(19) United States
(12) Patent Application Publication
(10) Pub. No.: US 2025/0242591 A1
(43) Pub. Date: Jul. 31, 2025

(54) LIQUID EJECTING APPARATUS, CONTROL METHOD FOR LIQUID EJECTING APPARATUS, AND NON-TRANSITORY COMPUTER-READABLE STORAGE MEDIUM STORING CONTROL PROGRAM FOR LIQUID EJECTING APPARATUS

(71) Applicant: SEIKO EPSON CORPORATION, Tokyo (JP)

(72) Inventors: Hiroaki OKUI, AZUMINO-SHI (JP); Nobuaki ITO, SUWA-SHI (JP)

(21) Appl. No.: 19/039,372

(22) Filed: Jan. 28, 2025

(30) Foreign Application Priority Data
Jan. 30, 2024 (JP) 2024011739

(51) Int. Cl. B41J 2/14; B41J 2/175; B41J 29/00

(52) U.S. Cl. CPC B41J 2/14233; B41J 2/17563; B41J 29/00; B41J 2002/14306

(57) ABSTRACT

A liquid ejecting apparatus includes a pump that applies a pressure for supplying the ink to the common flow path to the common flow path, a pump that applies a pressure for discharging the ink from the other common flow path to the other common flow path, a detection circuit that detects residual vibration in the pressure chamber after applying a voltage to the piezoelectric element, and a circulation control portion that determines the pressure for supplying the ink and the pressure for discharging the ink based on the residual vibration detected by the detection circuit.

The present application is based on, and claims priority from JP Application Serial Number 2024-011739, filed Jan. 30, 2024, the disclosure of which is hereby incorporated by reference herein in its entirety.

### BACKGROUND

### 1. Technical Field

The present disclosure relates to a liquid ejecting apparatus, a control method for the liquid ejecting apparatus, and a non-transitory computer-readable storage medium storing a control program for the liquid ejecting apparatus.

### 2. Related Art

A liquid ejecting apparatus such as an ink jet printer ejects a liquid from a liquid ejecting head after the liquid ejecting head is filled with the liquid such as an ink. In such a liquid ejecting head, in order to prevent retention of air bubbles in the liquid and thickening of the liquid, a technique of circulating the liquid in a flow path provided in the liquid ejecting head is proposed. For example, JP-A-2021-24082 discloses a liquid ejecting apparatus having a circulation mechanism that circulates an ink discharged from a liquid ejecting head in the liquid ejecting head.

In the liquid ejecting apparatus that circulates the liquid in the flow path provided in the liquid ejecting head, it is necessary to appropriately adjust a pressure in the vicinity of the nozzle in order to make an ejection characteristic of the liquid ejecting head have a desired characteristic.

### SUMMARY

According to an aspect of the present disclosure, there is provided a liquid ejecting apparatus including: a piezoelectric element; a plurality of individual flow paths each including a nozzle and a pressure chamber; a common supply flow path which communicates in common with the plurality of individual flow paths and through which a liquid is supplied to the plurality of individual flow paths; a common discharge flow path which communicates in common with the plurality of individual flow paths and through which the liquid is discharged from the plurality of individual flow paths; a first pressure applying portion that applies a first pressure for supplying the liquid to the common supply flow path, to the common supply flow path; a second pressure applying portion that applies a second pressure for discharging the liquid from the common discharge flow path, to the common discharge flow path; a detection portion that detects residual vibration in the pressure chamber after a voltage is applied to the piezoelectric element; and a pressure determination portion that determines each of the first pressure and the second pressure based on the residual vibration detected by the detection portion.

According to another aspect of the present disclosure, there is provided a control method for a liquid ejecting apparatus including a piezoelectric element, a plurality of individual flow paths each including a nozzle and a pressure chamber, a common supply flow path which communicates in common with the plurality of individual flow paths and through which a liquid is supplied to the plurality of individual flow paths, a common discharge flow path which communicates in common with the plurality of individual flow paths and through which the liquid is discharged from the plurality of individual flow paths, a first pressure applying portion that applies a first pressure for supplying the liquid to the common supply flow path, to the common supply flow path, a second pressure applying portion that applies a second pressure for discharging the liquid from the common discharge flow path, to the common discharge flow path, and a detection portion that detects residual vibration in the pressure chamber after a voltage is applied to the piezoelectric element, the method including: determining each of the first pressure and the second pressure based on the residual vibration detected by the detection portion.

According to still another aspect of the present disclosure, there is provided a non-transitory computer-readable storage medium storing a control program for a liquid ejecting apparatus including a piezoelectric element, a plurality of individual flow paths each including a nozzle and a pressure chamber, a common supply flow path which communicates in common with the plurality of individual flow paths and through which a liquid is supplied to the plurality of individual flow paths, a common discharge flow path which communicates in common with the plurality of individual flow paths and through which the liquid is discharged from the plurality of individual flow paths, a first pressure applying portion that applies a first pressure for supplying the liquid to the common supply flow path, to the common supply flow path, a second pressure applying portion that applies a second pressure for discharging the liquid from the common discharge flow path, to the common discharge flow path, and a detection portion that detects residual vibration in the pressure chamber after a voltage is applied to the piezoelectric element, the control program causing a computer to function as: a pressure determination portion that determines each of the first pressure and the second pressure based on the residual vibration detected by the detection portion.

### BRIEF DESCRIPTION OF THE DRAWINGS

FIG. 1 is a block diagram illustrating an example of a configuration of a liquid ejecting apparatus according to an embodiment of the present disclosure.

FIG. 2 is a configuration diagram schematically illustrating the liquid ejecting apparatus.

FIG. 3 is an exploded perspective view illustrating an example of a configuration of a liquid ejecting head.

FIG. 4 is a cross-sectional diagram illustrating the example of the configuration of the liquid ejecting head.

FIG. 5 is an explanatory diagram describing a flow of an ink.

FIG. 6 is a block diagram illustrating an example of a configuration of the liquid ejecting head.

FIG. 7 is a timing chart illustrating an example of an operation of the liquid ejecting apparatus in a unit period.

FIG. 8 is an explanatory diagram describing an outline of an operation of a circulation control portion.

FIG. 9 is a flowchart illustrating an example of an operation of the liquid ejecting apparatus.

FIG. 10 is an exploded perspective view illustrating an example of a configuration of a liquid ejecting head according to a first modification example.

FIG. 11 is a cross-sectional diagram illustrating the example of the configuration of the liquid ejecting head illustrated in FIG. 10.

FIG. 12 is an explanatory diagram describing a flow of inks in the first modification example.

### DESCRIPTION OF EMBODIMENTS

Hereinafter, embodiments for carrying out the present disclosure will be described with reference to the drawings. Meanwhile, in each drawing, the size and scale of each portion are appropriately different from the actual ones. The embodiments described below are preferred specific examples of the present disclosure and are thus added with technically preferred various limitations, but the scope of the present disclosure is not limited to such embodiments unless description for limiting the present disclosure is made in the following description.

### 1. Embodiment

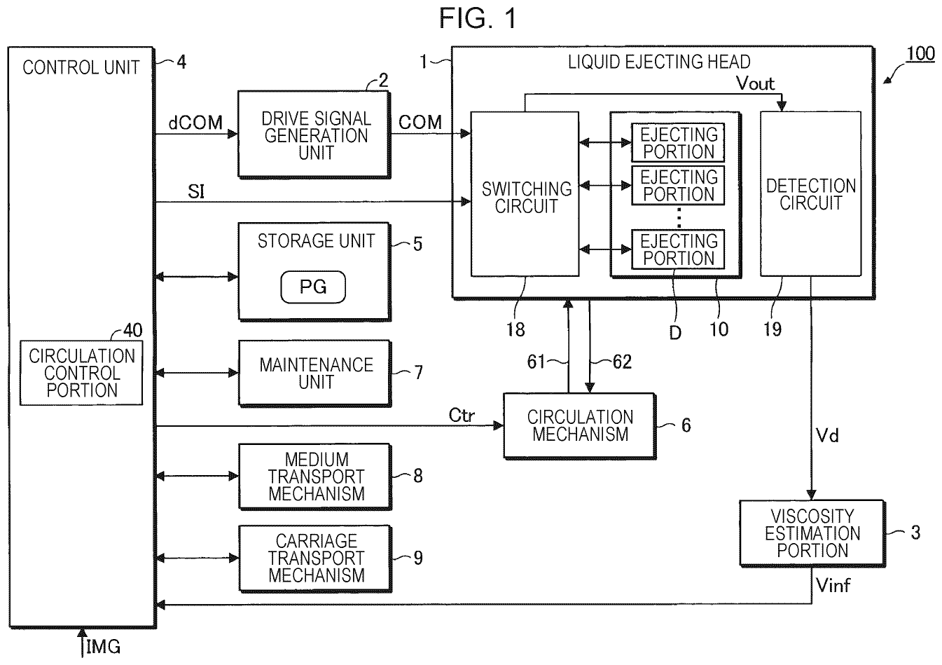

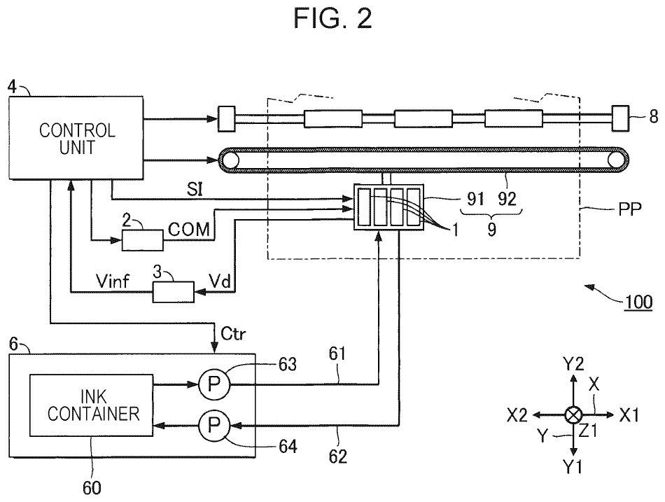

First, an outline of a liquid ejecting apparatus 100 according to the present embodiment will be described with reference to FIG. 1. In the present embodiment, it is assumed that the liquid ejecting apparatus 100 is an ink jet printer that ejects an ink to a medium PP to form an image, as an example. In the present embodiment, a recording paper illustrated in FIG. 2 to be described below is assumed as the medium PP.

FIG. 1 is a block diagram illustrating an example of a configuration of the liquid ejecting apparatus 100 according to an embodiment of the present disclosure.

For example, print data IMG indicating an image to be formed by the liquid ejecting apparatus 100 is supplied to the liquid ejecting apparatus 100 from a host computer such as a personal computer or a digital camera. The liquid ejecting apparatus 100 executes a printing process of forming the image indicated by the print data IMG supplied from the host computer on the medium PP.

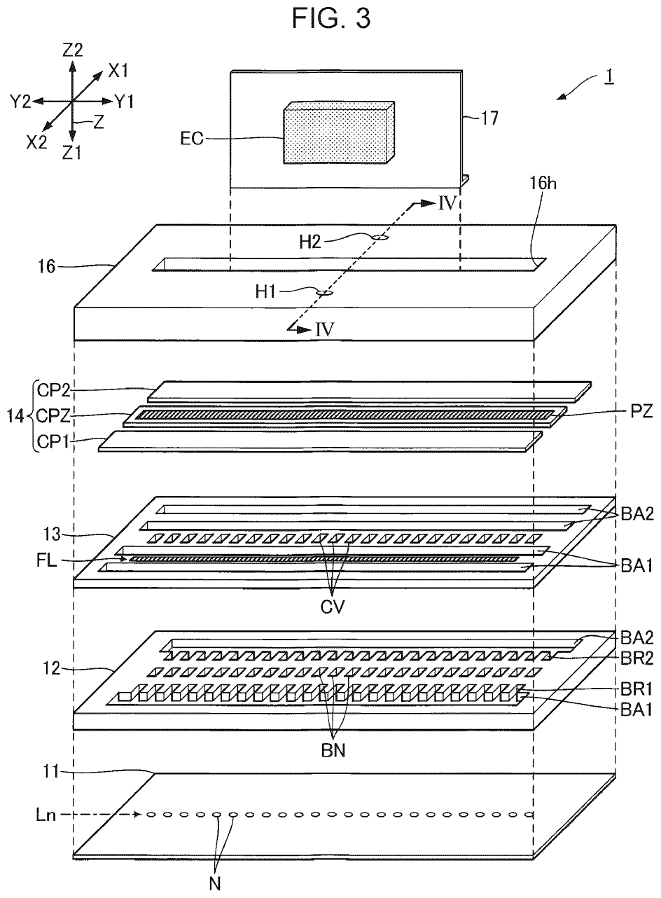

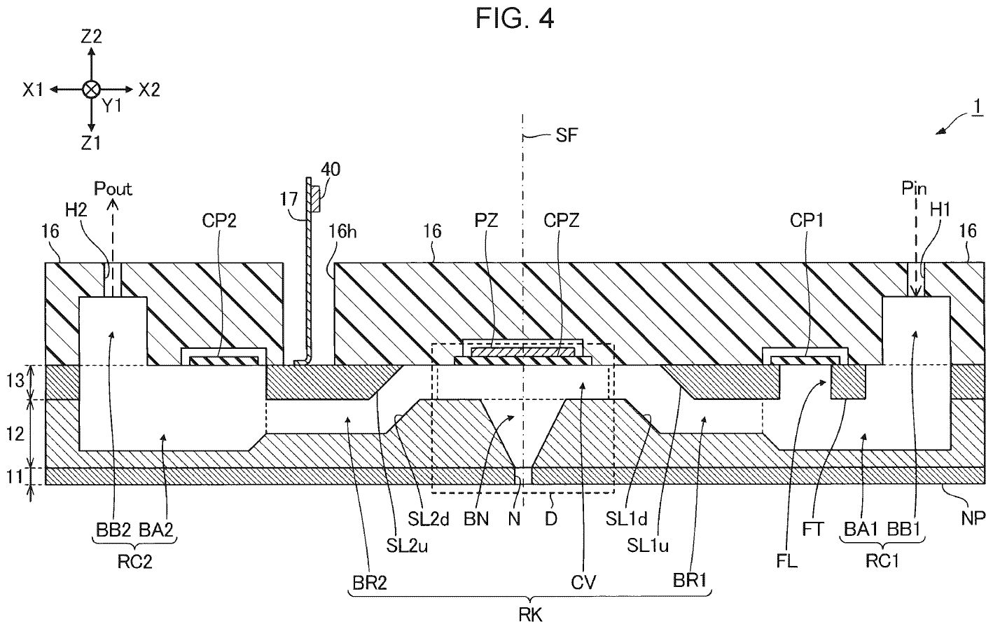

The liquid ejecting apparatus 100 includes a liquid ejecting head 1 provided with an ejecting portion D including a nozzle N that ejects an ink, a drive signal generation unit 2 that generates a plurality of drive signals COM for driving the ejecting portion D, and a viscosity estimation portion 3 that estimates a viscosity of the ink in the ejecting portion D. The nozzles N will be described below with reference to FIGS. 3 and 4. Further, the liquid ejecting apparatus 100 includes a control unit 4 that controls each portion of the liquid ejecting apparatus 100, and a storage unit 5 that stores various types of information such as the print data IMG and a control program PG of the liquid ejecting apparatus 100. Further, the liquid ejecting apparatus 100 includes a circulation mechanism 6 that circulates the ink, a maintenance unit 7 that executes a maintenance process on the liquid ejecting head 1, a medium transport mechanism 8 that transports the medium PP, and a carriage transport mechanism 9 that reciprocates a carriage 91. The carriage 91 will be described below with reference to FIG. 2.

In the present embodiment, a case is assumed in which the liquid ejecting head 1 and the drive signal generation unit 2 correspond to each other, the liquid ejecting head 1 and the viscosity estimation portion 3 correspond to each other, and the liquid ejecting head 1 and the circulation mechanism 6 correspond to each other. For example, the liquid ejecting apparatus 100 may include a plurality of liquid ejecting heads 1, a plurality of drive signal generation units 2, a plurality of viscosity estimation portions 3, and a plurality of circulation mechanisms 6. In this case, for example, the plurality of drive signal generation units 2 correspond to the plurality of liquid ejecting heads 1 on a one-to-one basis, the plurality of viscosity estimation portions 3 correspond to the plurality of liquid ejecting heads 1 on a one-to-one basis, and the plurality of circulation mechanisms 6 correspond to the plurality of liquid ejecting heads 1 on a one-to-one basis. Alternatively, the liquid ejecting apparatus 100 may include one liquid ejecting head 1, one drive signal generation unit 2 corresponding to the liquid ejecting head 1, one viscosity estimation portion 3 corresponding to the liquid ejecting head 1, and one circulation mechanism 6 corresponding to the liquid ejecting head 1.

In the present embodiment, a case is assumed in which the liquid ejecting apparatus 100 has four liquid ejecting heads 1 respectively corresponding to four types of an ink of cyan, magenta, yellow, and black. That is, in the present embodiment, a case is assumed in which the liquid ejecting apparatus 100 includes four liquid ejecting heads 1, four drive signal generation units 2, four viscosity estimation portions 3, and four circulation mechanisms 6. Meanwhile, in the following, for convenience of description, as illustrated in FIG. 1, one liquid ejecting head 1 of the four liquid ejecting heads 1, one drive signal generation unit 2 corresponding to the one liquid ejecting head 1, one viscosity estimation portion 3, and one circulation mechanism 6 may be focused on and described.

First, the control unit 4, the drive signal generation unit 2, and the storage unit 5 will be described before the liquid ejecting head 1 is to be described.

The control unit 4 is configured with one or a plurality of central processing units (CPU). The control unit 4 may be configured with a programmable logic device such as a field-programmable gate array (FPGA), instead of the CPU or in addition to the CPU. Further, for example, the control unit 4 generates a signal for controlling an operation of each portion of the liquid ejecting apparatus 100, such as a print signal SI and a waveform designation signal dCOM, by operating according to the control program PG stored in the storage unit 5.

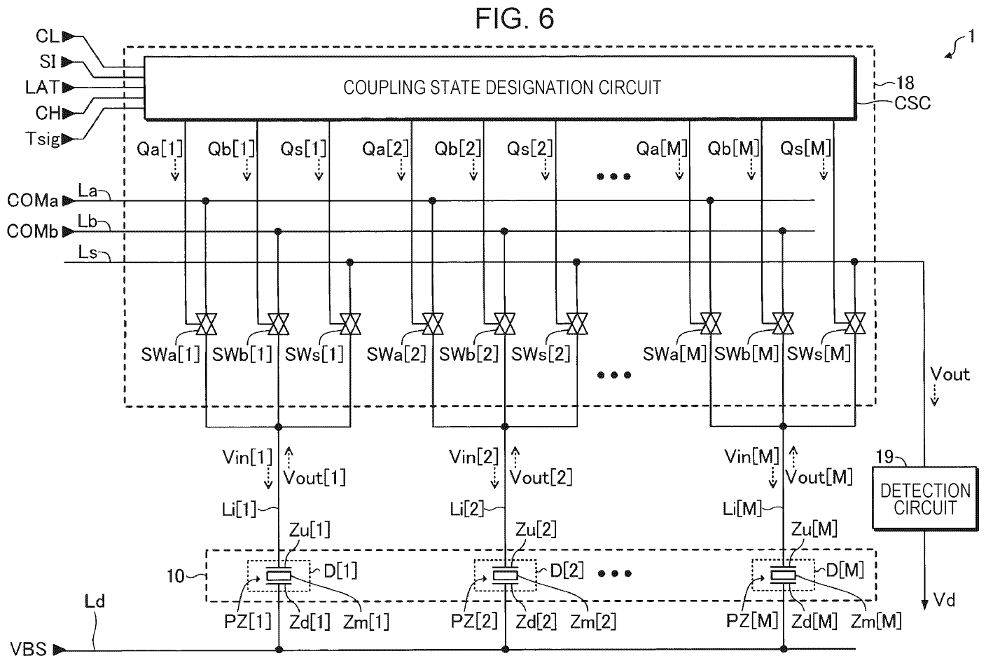

Here, the waveform designation signal dCOM is a digital signal that defines each of waveforms of the plurality of drive signals COM. In addition, each drive signal COM is an analog signal used to drive the ejecting portion D. In the present embodiment, as illustrated in FIG. 6 and the like to be described below, it is assumed that the plurality of drive signals COM include drive signals COMa and COMb. The print signal SI is a digital signal for designating a type of operation of the ejecting portion D. Specifically, the print signal SI is a signal for designating the type of operation of the ejecting portion D by designating whether or not to supply each drive signal COM to the ejecting portion D.

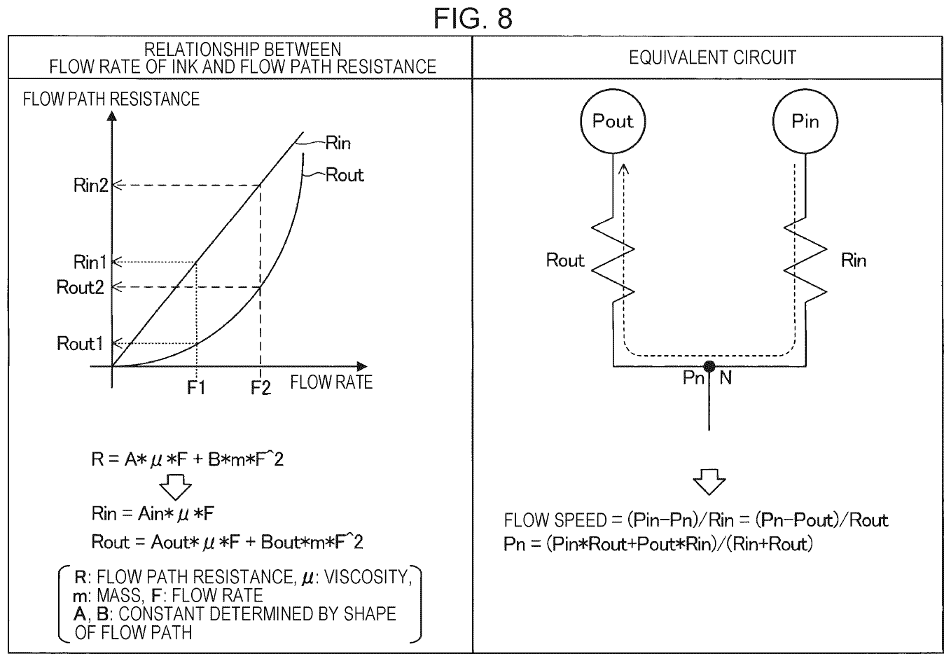

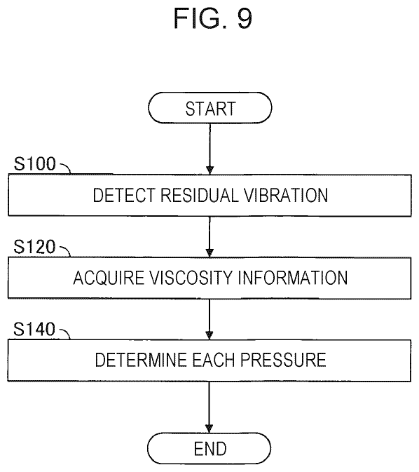

In the present embodiment, the control unit 4 functions as a circulation control portion 40 that controls the circulation mechanism 6 by operating according to the control program PG stored in the storage unit 5. For example, the circulation control portion 40 generates a control signal Ctr for controlling the operation of the circulation mechanism 6, and outputs the generated control signal Ctr to the circulation mechanism 6. The control unit 4 is an example of a “computer”, and the circulation control portion 40 is an example of a “pressure determination portion”. Details of the operation of the circulation control portion 40 will be described with reference to FIGS. 8 and 9.

The drive signal generation unit 2 includes, for example, a digital analog converter (DAC), and generates the plurality of drive signals COM based on the waveform designation signal dCOM supplied from the control unit 4. For example, each of the plurality of drive signals COM generated by the drive signal generation unit 2 includes a waveform defined by the waveform designation signal dCOM. The drive signal generation unit 2 outputs the plurality of drive signals COM generated based on the waveform designation signal dCOM to a switching circuit 18 included in the liquid ejecting head 1.

The storage unit 5 is configured to include one or both of a volatile memory such as a random access memory (RAM), and a non-volatile memory such as a read only memory (ROM), an electrically erasable programmable read-only memory (EEPROM), or a programmable ROM (PROM). The storage unit 5 may be included in the control unit 4.

The liquid ejecting head 1 includes the switching circuit 18, a recording head 10, and a detection circuit 19.

The recording head 10 includes M ejecting portions D. A value of M is a natural number of 1 or more. Hereinafter, among the M ejecting portions D provided in the recording head 10, a j-th ejecting portion D may be referred to as an ejecting portion D[j]. Here, the variable j is a natural number satisfying “1≤j≤M”. Further, in the following, when the components, signals, or the like of the liquid ejecting apparatus 100 correspond to the ejecting portion D[j] among the M ejecting portions D, the subscript [j] may be added to the reference numerals for representing the components, signals, or the like.

The switching circuit 18 switches whether or not to supply each drive signal COM to the ejecting portion D[j], based on the print signal SI. In the following, as illustrated in FIG. 6 and the like to be described below, the drive signal COM supplied to the ejecting portion D[j] among the plurality of drive signals COM may be referred to as an individual drive signal Vin[j]. Further, the switching circuit 18 switches whether or not to electrically couple the ejecting portion D[j] and the detection circuit 19 based on the print signal SI. When the ejecting portion D[j] and the detection circuit 19 are electrically coupled to each other, for example, a detection signal Vout[j] detected from the ejecting portion D[j] is supplied to the detection circuit 19 via the switching circuit 18. The detection signal Vout[j] indicates, for example, a waveform of residual vibration, which is vibration remaining in the ejecting portion D[j] after the ejecting portion D[j] is driven by the individual drive signal Vin[j].

The detection circuit 19 generates a residual vibration signal Vd[j] based on the detection signal Vout[j]. For example, the detection circuit 19 amplifies an amplitude of the detection signal Vout[j] or removes a noise component included in the detection signal Vout[j] to shape the detection signal Vout[j] into a waveform appropriate for a process in the viscosity estimation portion 3. Therefore, the residual vibration signal Vd[j] is generated. For example, the detection circuit 19 may have a configuration including a negative feedback type amplifier for amplifying the detection signal Vout[j], a low-pass filter for attenuating a high-frequency component of the detection signal Vout[j], and a voltage follower that converts an impedance and outputs a low-impedance residual vibration signal Vd[j].

The detection circuit 19 outputs the residual vibration signal Vd[j] generated based on the detection signal Vout[j] to the viscosity estimation portion 3. The detection circuit 19 is an example of a “detection portion”.

The viscosity estimation portion 3 estimates a viscosity of an ink in the ejecting portion D[j], for example, based on the residual vibration signal Vd[j]. For example, the residual vibration signal Vd[j] used to estimate the viscosity of the ink in the ejecting portion D[j] is generated based on the detection signal Vout[j], and thus indicates a waveform of residual vibration of the ejecting portion D[j] after being driven by the individual drive signal Vin[j].

For example, the viscosity estimation portion 3 may detect a relative viscosity with respect to a predetermined viscosity by comparing the feature amount such as an amplitude and a cycle of the residual vibration signal Vd[j] with the reference feature amount of the residual vibration signal when the viscosity of the ink is the predetermined viscosity. Alternatively, the viscosity estimation portion 3 may calculate an attenuation factor of the residual vibration based on an attenuation factor of the amplitude of the residual vibration signal Vd[j], and estimate the viscosity of the ink based on the calculated attenuation factor of the residual vibration.

In addition, the viscosity estimation portion 3 generates, for example, viscosity information Vinf indicating the viscosity of the ink estimated based on the residual vibration, and outputs the generated viscosity information Vinf to the control unit 4. The viscosity estimation portion 3 may be included in the control unit 4. For example, the control unit 4 may function as the viscosity estimation portion 3 by operating according to the control program PG stored in the storage unit 5. In addition, an element including the viscosity estimation portion 3 and the circulation control portion 40 may be regarded as a “pressure determination portion”.

Further, in the present embodiment, as described above, the maintenance process is executed by the maintenance unit 7. For example, the maintenance unit 7 executes the maintenance process under the control of the control unit 4. For example, the maintenance process includes flushing processing of discharging inks from the ejecting portion D, wiping processing of wiping off a foreign matter such as an ink adhering to the vicinity of a nozzle N of the ejecting portion D with a wiper, and pumping processing of suctioning the ink in the ejecting portion D with a tube pump or the like.

The maintenance unit 7 includes a discharge ink receiving portion for receiving the discharged ink when the ink in the ejecting portion D is discharged, a wiper for wiping off a foreign matter such as an ink adhering to the vicinity of the nozzle N of the ejecting portion D, and a tube pump for suctioning the ink, air bubbles, and the like in the ejecting portion D, in the flushing processing. The discharge ink receiving portion, the wiper, and the tube pump are not illustrated.

The configuration of the liquid ejecting apparatus 100 is not limited to the example illustrated in FIG. 1. For example, the viscosity estimation portion 3 may have a function of determining an ejection state of the nozzle N included in the ejecting portion D[j] based on the residual vibration signal Vd[j]. In this case, for example, the viscosity estimation portion 3 may determine the ejection state of the nozzle N by comparing a detection value such as an amplitude and a cycle of the residual vibration signal Vd[j] with a reference value when the ejection state of the nozzle N is normal.

Next, a schematic overall configuration of the liquid ejecting apparatus 100 will be described with reference to FIG. 2.

FIG. 2 is a configuration diagram schematically illustrating the liquid ejecting apparatus 100. In FIG. 2, the circulation mechanism 6, the medium transport mechanism 8, and the carriage transport mechanism 9 will be mainly described.

The circulation mechanism 6 supplies an ink stored in the circulation mechanism 6 to the liquid ejecting head 1 based on a control signal Ctr supplied from the control unit 4. Further, the circulation mechanism 6 collects the ink from the liquid ejecting head 1 based on the control signal Ctr supplied from the control unit 4, and returns the collected ink to the liquid ejecting head 1.

For example, the circulation mechanism 6 includes an ink container 60 that stores inks, a pump 63 coupled to a supply flow path 61 through which the inks are supplied to the liquid ejecting head 1, and a pump 64 coupled to a collection flow path 62 through which the inks discharged from the liquid ejecting head 1 are collected. As the ink container 60, for example, a cartridge that can be attached to and detached from the liquid ejecting apparatus 100, a bag-shaped ink pack formed of a flexible film, or an ink tank that can be replenished with inks can be adopted. A type of the ink stored in the ink container 60 is not particularly limited, and is optional. In addition, the pump 63 is an example of a “first pressure applying portion”, and the pump 64 is an example of a “second pressure applying portion”.

The pumps 63 and 64 are controlled by the control unit 4. For example, the pump 63 supplies the ink stored in the ink container 60 to the liquid ejecting head 1 via the supply flow path 61 based on the control signal Ctr supplied from the control unit 4. For example, the pump 64 collects the ink from the liquid ejecting head 1 via the collection flow path 62 based on the control signal Ctr supplied from the control unit 4, and supplies the collected ink to the ink container 60.

The circulation mechanism 6 may be defined without including the ink container 60, or may be defined to include the supply flow path 61 and the collection flow path 62.

The medium transport mechanism 8 transports the medium PP in a Y1 direction along a Y-axis under the control of the control unit 4. Hereinafter, the Y1 direction and a Y2 direction opposite to the Y1 direction are collectively referred to as a Y-axis direction. In addition, hereinafter, an X1 direction along an X-axis that intersects the Y-axis and an X2 direction opposite to the X1 direction are collectively referred to as an X-axis direction. In addition, hereinafter, a Z1 direction along a Z-axis that intersects the X-axis and the Y-axis and a Z2 direction opposite to the Z1 direction are collectively referred to as a Z-axis direction. In the present embodiment, as an example, description will be performed by assuming that the X-axis, the Y-axis, and the Z-axis are orthogonal to each other. Meanwhile, the present disclosure is not limited to such an aspect. The X-axis, the Y-axis, and the Z-axis may intersect each other.

The carriage transport mechanism 9 reciprocates the plurality of liquid ejecting heads 1 in the X1 direction and the X2 direction under the control of the control unit 4. As illustrated in FIG. 2, the carriage transport mechanism 9 includes the substantially box-shaped carriage 91 that accommodates the plurality of liquid ejecting heads 1, and an endless belt 92 to which the carriage 91 is fixed. The circulation mechanism 6 may be stored in the carriage 91 together with the liquid ejecting head 1.

The liquid ejecting head 1 is driven by the drive signal COM under the control of the print signal SI, and ejects the ink in the Z1 direction from some or all of the plurality of nozzles N provided in the liquid ejecting head 1. That is, the liquid ejecting head 1 forms a desired image on a surface of the medium PP by ejecting the ink from the some or all of the plurality of nozzles N in conjunction with transport of the medium PP by the medium transport mechanism 8 and a reciprocating motion of the liquid ejecting head 1 by the carriage transport mechanism 9 and landing the ejected ink on the surface of the medium PP.

Next, a schematic structure of the liquid ejecting head 1 will be described with reference to FIGS. 3 and 4.

FIG. 3 is an exploded perspective view illustrating an example of a configuration of the liquid ejecting head 1. FIG. 4 is a cross-sectional diagram illustrating the example of the configuration of the liquid ejecting head 1. The cross-sectional diagram illustrated in FIG. 4 is a cross-sectional diagram taken along a line IV-IV illustrated in FIG. 3. A cross section taken along the line IV-IV is parallel to the XZ plane and passes through coupling ports H1 and H2 to be described below. In addition, in FIG. 4, a reference plane SF referred to in a modification example to be described below is also illustrated by a one-dot chain line.

As illustrated in FIGS. 3 and 4, the liquid ejecting head 1 includes a nozzle substrate 11, a communication plate 12, a pressure chamber substrate 13, a diaphragm 14, a flow path forming substrate 16, and a wiring substrate 17 at which an electronic component EC is mounted. The electronic component EC includes, for example, an electric circuit such as the switching circuit 18 and the detection circuit 19. For example, the recording head 10 is electrically coupled to the switching circuit 18, the detection circuit 19, and the like via the wiring substrate 17.

As illustrated in FIG. 3, the nozzle substrate 11 is a plate-shaped member elongated in the Y-axis direction and extending substantially parallel to an XY plane. Here, “substantially parallel” is a concept that includes not only a case of being completely parallel but also a case of being considered to be parallel when an error is considered. In the present embodiment, “substantially parallel” is a concept that includes a case where it can be regarded as parallel when an error of approximately 10% is considered. The nozzle substrate 11 is manufactured, for example, by processing a silicon single crystal substrate using a semiconductor manufacturing technology such as etching, and any known material and manufacturing method may be adopted to manufacture the nozzle substrate 11.

M nozzles N are formed at the nozzle substrate 11. Here, the nozzle Nis a through-hole provided in the nozzle substrate 11. A surface NP of the nozzle substrate 11 in the Z1 direction corresponds to a nozzle surface. In the present embodiment, a case is assumed in which the M nozzles N are arranged to extend in the Y-axis direction, at the nozzle substrate 11. Hereinafter, the M nozzles N extending in the Y-axis direction may be referred to as a nozzle row Ln.

As illustrated in FIGS. 3 and 4, the communication plate 12 is provided at a position in the Z2 direction with respect to the nozzle substrate 11. The communication plate 12 is a plate-shaped member elongated in the Y-axis direction and extending substantially parallel to the XY plane. The communication plate 12 is manufactured, for example, by processing a silicon single crystal substrate using semiconductor manufacturing technology, and any known material and manufacturing method may be adopted to manufacture the communication plate 12.

As illustrated in FIGS. 3 and 4, the pressure chamber substrate 13 is provided at a position in the Z2 direction with respect to the communication plate 12. The pressure chamber substrate 13 is a plate-shaped member elongated in the Y-axis direction and extending substantially parallel to the XY plane. The pressure chamber substrate 13 is manufactured, for example, by processing a silicon single crystal substrate using semiconductor manufacturing technology, and any known material and manufacturing method may be adopted to manufacture the pressure chamber substrate 13.

A flow path for inks is formed in the communication plate 12 and the pressure chamber substrate 13. Specifically, the communication plate 12 and the pressure chamber substrate 13 are formed with one common flow path BA1 provided to extend in the Y-axis direction and one common flow path BA2 provided to extend in the Y-axis direction. The common flow path BA2 is located in the X1 direction with respect to the common flow path BA1.

In addition, M coupling flow paths BR1 corresponding to the M nozzles N are formed in the communication plate 12 and the pressure chamber substrate 13. In addition, M coupling flow paths BR2 corresponding to the M nozzles N are formed in the communication plate 12 and the pressure chamber substrate 13. Further, M nozzle flow paths BN corresponding to the M nozzles N are formed in the communication plate 12. In addition, M pressure chambers CV corresponding to M nozzles N are formed in the pressure chamber substrate 13.

The coupling flow path BR1 is provided to extend in the X-axis direction, at a position in the X1 direction with respect to the common flow path BA1, and communicates with the common flow path BA1. The coupling flow path BR2 is provided to extend in the X-axis direction, at a position in the X2 direction with respect to the common flow path BA2, and communicates with the common flow path BA2. The pressure chamber CV is located between the coupling flow path BR1 and the coupling flow path BR2, and communicates with the coupling flow path BR1 and the coupling flow path BR2. Further, the pressure chamber CV communicates with the nozzle flow path BN. The nozzle flow path BN is provided at a position in the Z1 direction with respect to the pressure chamber CV, and communicates with the nozzle N.

In the following, the common flow path BA1 and the common flow path BA2 may be collectively referred to as a common flow path BA, and the coupling flow path BR1 and the coupling flow path BR2 may be collectively referred to as a coupling flow path BR.

In addition, in the following, the coupling flow path BR1, the pressure chamber CV communicating with the coupling flow path BR1, and the coupling flow path BR2 communicating with the pressure chamber CV may be referred to as an individual flow path RK. In addition, in the following, the individual flow path RK corresponding to a j-th nozzle N among the M nozzles N may be referred to as an individual flow path RK[j]. In the present embodiment, the individual flow path RK[j] is defined to include the j-th nozzle N among the M nozzles N. That is, in the present embodiment, the individual flow path RK[j] has the j-th nozzle N and the pressure chamber CV corresponding to the j-th nozzle N. In the present embodiment, the M individual flow paths RK[1] to RK[M] corresponding to the M nozzles N are arranged along the Y-axis direction. In the present embodiment, each individual flow path RK extends in the X-axis direction.

In FIG. 4, a case is illustrated in which a wall surface of the individual flow path RK includes surfaces SL1d, SL1u, SL2d, and SL2u that are inclined with respect to a YZ plane, and the wall surface of the individual flow path RK is not limited to the shape illustrated in FIG. 4. For example, the surfaces SL1d, SL1u, SL2d, and SL2u may be substantially parallel to the YZ plane. In the present embodiment, a case is assumed as an example in which a wall surface defining an end portion of the individual flow path RK in the Z1 direction is configured with the communication plate 12, and the end portion of the individual flow path RK in the Z1 direction may be configured with the nozzle substrate 11. As illustrated in FIGS. 3 and 4, the diaphragm 14 is provided at a position in the Z2 direction with respect to the pressure chamber substrate 13. The diaphragm 14 has a diaphragm CPZ, a vibration absorption plate CP1, and a vibration absorption plate CP2. Each of the diaphragm CPZ, the vibration absorption plate CP1, and the vibration absorption plate CP2 is a plate-shaped member that is elongated in the Y-axis direction and extends substantially parallel to the XY plane, and is an elastically vibratable member. Each of the diaphragm CPZ, the vibration absorption plate CP1, and the vibration absorption plate CP2 has, for example, an elastic film made of silicon oxide and an insulator film made of zirconium oxide. The elastic film of each of the diaphragm CPZ, the vibration absorption plate CP1, and the vibration absorption plate CP2 is not limited to the elastic film made of silicon oxide. In the same manner, the insulator film of each of the diaphragm CPZ, the vibration absorption plate CP1, and the vibration absorption plate CP2 is not limited to the insulator film made of zirconium oxide.

The diaphragm CPZ is provided at a position in the Z2 direction with respect to the pressure chamber CV. M piezoelectric elements PZ corresponding to the M pressure chambers CV are provided on a surface of the diaphragm CPZ in the Z2 direction. Here, a surface of a first element in a first direction is a surface of the first element, which is substantially perpendicular to the first direction among surfaces of the first element, and is a surface that is visible when the first element is viewed from the first direction in a second direction. The second direction is a direction opposite to the first direction. In addition, an expression “an second element is formed at the surface of the first element” in the present specification is not intended to limit the configuration in which the first element and the second element are in direct contact with each other. That is, a configuration in which a third element is formed at the surface of the first element and the second element is formed at a surface of the third element is also included in the concept of “the second element is formed at the surface of the first element”, insofar as the first element and the second element overlaps at least in part in plan view.

Although not illustrated in FIGS. 3 and 4, the piezoelectric element PZ has a common electrode Zd to which a predetermined bias potential VBS is supplied, an individual electrode Zu to which an individual drive signal Vin is supplied, and a piezoelectric layer Zm provided between the individual electrode Zu and the common electrode Zd, as illustrated in FIG. 6. For example, the common electrode Zd, the piezoelectric layer Zm, and the individual electrode Zu are provided in this order along the Z2 direction, on the surface of the diaphragm CPZ in the Z2 direction. In the present embodiment, the common electrode Zd is a so-called lower electrode, and the individual electrode Zu is a so-called upper electrode, and the common electrode Zd may be an upper electrode and the individual electrode Zu may be a lower electrode.

The piezoelectric element PZ is a passive element that is deformed in response to a potential change of the drive signal COM supplied to the individual electrode Zu as the individual drive signal Vin. Specifically, the piezoelectric element PZ is driven and deformed in response to a potential change of the drive signal COM.

As described above, since the piezoelectric element PZ is provided on the surface of the diaphragm CPZ in the Z2 direction, the diaphragm CPZ vibrates in conjunction with the deformation of the piezoelectric element PZ. When the diaphragm CPZ vibrates, a pressure in the pressure chamber CV fluctuates. Then, the pressure inside the pressure chamber CV fluctuates, and the ink with which an inside of the pressure chamber CV is filled is ejected from the nozzle N in the Z1 direction via the nozzle flow path BN.

The vibration absorption plate CP1 is provided at a position in the Z2 direction with respect to the common flow path BA1. The vibration absorption plate CP1 absorbs the vibration when the ink flowing in the common flow path BA1 vibrates in response to the pressure fluctuation in the pressure chamber CV. The vibration absorption plate CP2 is provided at a position in the Z2 direction with respect to the common flow path BA2. The vibration absorption plate CP2 absorbs the vibration when the ink flowing in the common flow path BA2 vibrates in response to the pressure fluctuation in the pressure chamber CV. Hereinafter, the vibration absorption plate CP1 and the vibration absorption plate CP2 may be collectively referred to as a vibration absorption plate CP.

As illustrated in FIGS. 3 and 4, the flow path forming substrate 16 is provided at a position in the Z2 direction with respect to the pressure chamber substrate 13. The flow path forming substrate 16 is a plate-shaped member elongated in the Y-axis direction and extending substantially parallel to the XY plane. The flow path forming substrate 16 is formed by, for example, injection molding of a resin material, and any known material and manufacturing method may be adopted to manufacture the flow path forming substrate 16.

A flow path for inks is formed in the flow path forming substrate 16. Specifically, as illustrated in FIG. 4, the flow path forming substrate 16 is formed with one common flow path BB1 and one common flow path BB2. The common flow path BB1 is provided to extend in the Y-axis direction at a position in the Z2 direction with respect to the common flow path BA1, and communicates with the common flow path BA1. The common flow path BB2 is provided to extend in the Y-axis direction at a position, which is a position in the Z2 direction with respect to the common flow path BA2 and in the X1 direction with respect to the common flow path BB1, and communicates with the common flow path BA2. In the following, the common flow path BB1 and the common flow path BB2 may be collectively referred to as a common flow path BB.

Hereinafter, the common flow path BA1 and the common flow path BB1 communicating with the common flow path BA1 may be referred to as a common flow path RC1. In addition, in the following, the common flow path BA2 and the common flow path BB2 communicating with the common flow path BA2 may be referred to as a common flow path RC2. Further, in the following, the common flow path RC1 and the common flow path RC2 may be collectively referred to as a common flow path RC. The common flow path RC1 is an example of a “common supply flow path”, and the common flow path RC2 is an example of a “common discharge flow path”.

The flow path forming substrate 16 is provided with a coupling port H1 that communicates with the common flow path BB1 and a coupling port H2 that communicates with the common flow path BB2. The supply flow path 61 is coupled to the coupling port H1, and the collection flow path 62 is coupled to the coupling port H2. For example, the pump 63 supplies an ink from the ink container 60 to the common flow path RC1 including the common flow path BB1 via the supply flow path 61 and the coupling port H1. In this case, a pressure Pin applied to the common flow path RC1 is, for example, a positive pressure more than an atmospheric pressure. The pressure chamber CV is filled with a part of the ink supplied to the common flow path RC1, via the coupling flow path BR1. When the piezoelectric element PZ is driven by the drive signal COM, the part of the ink with which the pressure chamber CV is filled is ejected from the nozzle N via the nozzle flow path BN. In addition, the part of the ink with which the pressure chamber CV is filled is discharged to the common flow path RC2 via the coupling flow path BR2.

For example, the pump 64 collects the part of the ink stored in the common flow path RC2 including the common flow path BB2 via the collection flow path 62 and the coupling port H2, and supplies the collected ink to the ink container 60. In this case, a pressure Pout applied to the common flow path RC2 is, for example, a negative pressure less than the atmospheric pressure. In this manner, the pressure Pin is a pressure for supplying the ink to the common flow path RC1, and the pressure Pout is a pressure for discharging the ink from the common flow path RC2. The pressure Pout may be equal to or more than the atmospheric pressure as long as the pressure Pout is less than the pressure Pin. The pressure Pin is an example of a “first pressure”, and the pressure Pout is an example of a “second pressure”.

Hereinafter, an increase in pressure Pin means, for example, an increase in force for supplying the ink to the common flow path RC1, that is, a pressure toward the pressure chamber CV, of the ink stored in the common flow path RC1. In addition, a decrease in pressure Pout means that a difference from the pressure Pin is increased, that is, the amount of pressure reduction applied to the common flow path RC2 is increased. Therefore, the decrease in pressure Pout means that a pressure for discharging the ink stored in the common flow path RC2 from the coupling port H2, that is, a force for discharging the ink from the common flow path RC2 is increased. When the pressure Pout is a negative pressure, the decrease in pressure Pout means that an absolute value of the pressure Pout is increased, and an increase in pressure Pout means that the absolute value of the pressure Pout is decreased. For example, the pump 63 functions as a pressurizing mechanism that pressurizes the pressure Pin, and the pump 64 functions as a decompression mechanism that decompresses the pressure Pout.

Here, for example, when the pressure Pout is more than an appropriate pressure with respect to the pressure Pin, there is a concern that the ink leaks from the nozzle N, and when the pressure Pout is less than an appropriate pressure with respect to the pressure Pin, there is a concern that the ink is not appropriately ejected from the nozzle N. Therefore, the pressure Pin and the pressure Pout are adjusted such that an ejection state of the ink is in a normal state.

The flow path forming substrate 16 is provided with a through-hole 16h. The through-hole 16h is a hole that is located between the common flow path BB1 and the common flow path BB2 when the flow path forming substrate 16 is viewed in the Z1 direction, and penetrates from a surface of the flow path forming substrate 16 in the Z1 direction to a surface of the flow path forming substrate 16 in the Z2 direction. The wiring substrate 17 is inserted into the through-hole 16h.

As illustrated in FIGS. 3 and 4, the wiring substrate 17 is mounted on a surface of the pressure chamber substrate 13 in the Z2 direction. The wiring substrate 17 is a component for electrically coupling the liquid ejecting head 1 to the control unit 4. As the wiring substrate 17, for example, a flexible wiring substrate such as a flexible printed circuit (FPC) or a flexible flat cable (FFC) is preferably adopted. As described above, the electronic component EC including the switching circuit 18, the detection circuit 19, and the like is mounted at the wiring substrate 17.

As illustrated in FIGS. 3 and 4, a filter FL is formed at the pressure chamber substrate 13. The filter FL is a structure for capturing air bubbles in the ink in the common flow path BA1. For example, the filter FL is configured with a plurality of protuberant portions FT arranged in the Y-axis direction. The filter FL captures air bubbles that float in the Z2 direction by buoyancy in the ink flowing in the common flow path BA1 by the two protuberant portions FT adjacent to each other in the Y-axis direction, among the plurality of protuberant portions FT. In the present embodiment, as an example, a case is assumed in which the plurality of protuberant portions FT are formed by the pressure chamber substrate 13. In the present embodiment, as an example, a case is assumed in which the plurality of protuberant portions FT are attached to a surface of the flow path forming substrate 16 in the Z1 direction.

In the present embodiment, as described above, since the common flow path BA1 is provided with the filter FL, mixing of a foreign matter in the ink ejected from the nozzle N can be prevented. In the present embodiment, since the ink is collected from the common flow path RC2 by the pump 64, a backflow of the ink from the common flow path BA2 to the nozzle N can be prevented. Therefore, in the present embodiment, the mixing of the foreign matter in the ink ejected from the nozzle N can be prevented, even in a configuration in which the filter FL is not provided in the common flow path BA2. In addition, by not providing the filter FL in the common flow path BA2, the filter FL can be prevented from being a limiting factor in the flow of the ink in the common flow path BA2. The filter FL is not limited to being configured with the plurality of protuberant portions FT arranged in the Y-axis direction.

In this manner, in the present embodiment, the filter FL is provided in only one of a first flow path between the pump 63 and the plurality of individual flow paths RK and a second flow path between the pump 64 and the plurality of individual flow paths RK. For example, the first flow path includes the common flow path RC1 and the supply flow path 61, and the second flow path includes the common flow path RC2 and the collection flow path 62.

Here, as illustrated in FIG. 4, the ejecting portion D includes the piezoelectric element PZ, the pressure chamber CV, and the nozzle N. In addition, the residual vibration of the ejecting portion D[j] described above is more specifically vibration remaining in the pressure chamber CV included in the ejecting portion D[j].

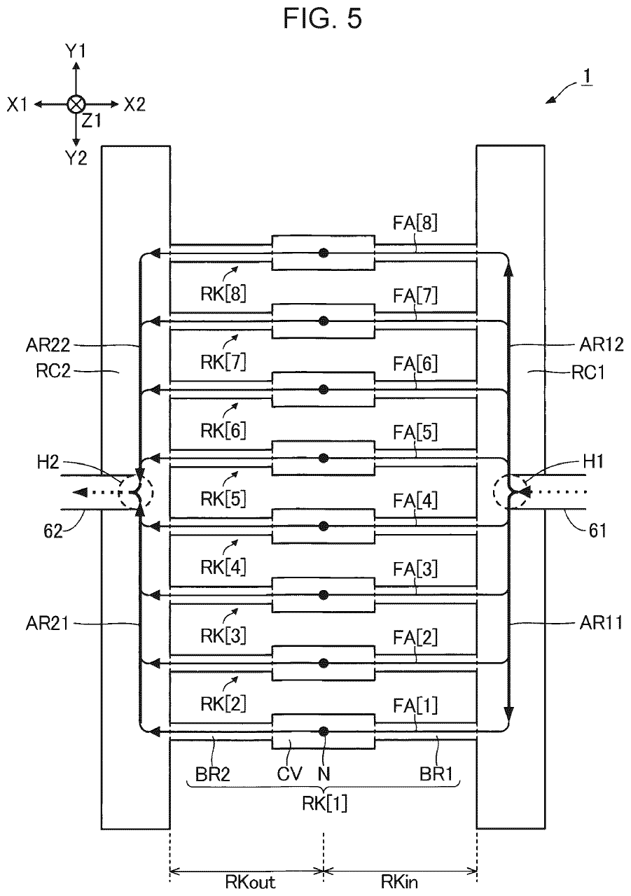

Next, a flow of inks will be described with reference to FIG. 5.

FIG. 5 is an explanatory diagram describing the flow of the ink. FIG. 5 illustrates the flow of the ink in the common flow path RC and the individual flow path RK when the liquid ejecting head 1 is viewed in plan view in the Z1 direction. Meanwhile, in FIG. 5, for convenience of illustration, the supply flow path 61 and the collection flow path 62 are described as extending in the X-axis direction. Meanwhile, the supply flow path 61 and the collection flow path 62 are not limited to extending in the X-axis direction. In addition, in FIG. 5, as an example, it is assumed that the value M is “8”. In addition, in FIG. 5, a case is assumed in which each of the coupling port H1 and the coupling port H2 is located between the individual flow path RK[4] and the individual flow path RK[5] in the Y-axis direction.

When the ink is circulated, the supply flow path 61 supplies the ink to the common flow path RC1, and the collection flow path 62 collects the ink from the common flow path RC2. For example, in the common flow path RC1, the ink flows from the coupling port H1 in the Y1 direction and the Y2 direction as illustrated by arrows AR11 and AR12. An ink flowing from the coupling port H1 in the Y1 direction is supplied to the individual flow paths RK[5] to RK[8], and an ink flowing from the coupling port H1 in the Y2 direction is supplied to the individual flow paths RK[1] to RK[4].

Further, in the individual flow path RK[j], the ink flows from the common flow path RC1 to the common flow path RC2 in the X1 direction as indicated by an arrow FA[j]. Therefore, for example, the pressure chamber CV provided in the individual flow path RK[j] is filled with the ink.

In addition, for example, in the common flow path RC2, as illustrated by arrows AR21 and AR22, an ink flows from the individual flow paths RK[1] to RK[4] in the Y1 direction, and an ink flows from the individual flow paths RK[5] to RK[8] in the Y2 direction. That is, the ink discharged from the individual flow paths RK[1] to RK[4] flows in the Y1 direction and is collected in the collection flow path 62 via the coupling port H2. In addition, the ink discharged from the individual flow paths RK[5] to RK[8] flows in the Y2 direction and is collected in the collection flow path 62 via the coupling port H2. In the following, a portion of the individual flow path RK[j] between the common flow path RC1 and the nozzle N may be referred to as an individual flow path RKin[j], and a portion of the individual flow path RK[j] between the nozzle N and the common flow path RC2 may be referred to as an individual flow path RKout[j].

In this manner, the common flow path RC1 communicates in common with a plurality of individual flow paths RK, and supplies the ink to the plurality of individual flow paths RK. The common flow path RC2 communicates in common with the plurality of individual flow paths RK, and discharges the ink from the plurality of individual flow paths RK. In the present embodiment, a case is assumed in which the ink is circulated as illustrated in FIG. 5 in a recovery process of recovering an ejection state of the nozzle N to a normal state and a printing process of forming an image indicated by the print data IMG on a medium.

Further, in the present embodiment, as described above, the coupling port H1 is provided between the individual flow path RK[4] and the individual flow path RK[5] in the Y-axis direction. That is, in the present embodiment, the coupling port H1 is provided between the individual flow path RK[1] and the individual flow path RK[M] in the Y-axis direction. Therefore, in the present embodiment, the pressure Pin required for supplying the ink from the coupling port H1 to the M individual flow paths RK can be reduced, as compared with a mode in which the coupling port H1 is provided in the Y2 direction with respect to the individual flow path RK[1] and a mode in which the coupling port H1 is provided in the Y1 direction with respect to the individual flow path RK[M]. As a result, in the present embodiment, power related to the driving of the circulation mechanism 6 can be reduced.

In the present embodiment, in the Y-axis direction, the coupling port H1 is provided between the individual flow path RK[1] and the individual flow path RK[M], and the coupling port H2 is provided between the individual flow path RK[1] and the individual flow path RK[M]. Therefore, in the present embodiment, the retention of the ink in the common flow path RC1 can be prevented without providing a plurality of coupling ports H1 coupled to the common flow path RC1, and the retention of the ink in the common flow path RC2 can be prevented without providing a plurality of coupling ports H2 coupled to the common flow path RC2. Therefore, in the present embodiment, the retention of the ink in the common flow path RC1 and the common flow path RC2 can be prevented with a simpler configuration, as compared with a mode in which the plurality of coupling ports H1 coupled to the common flow path RC1 and a mode in which the plurality of coupling ports H2 coupled to the common flow path RC2 are provided.

Next, an outline of the liquid ejecting head 1 will be described with reference to FIG. 6.

FIG. 6 is a block diagram illustrating an example of a configuration of the liquid ejecting head 1.

As described in FIG. 1, the liquid ejecting head 1 includes the recording head 10, the switching circuit 18, and the detection circuit 19. The liquid ejecting head 1 also includes a wiring La to which the drive signal COMa is supplied from the drive signal generation unit 2, a wiring Lb to which the drive signal COMb is supplied from the drive signal generation unit 2, and a wiring Ls via which the detection signal Vout is supplied to the detection circuit 19. Further, the liquid ejecting head 1 has a wiring Li[j] through which the individual drive signal Vin[j] is supplied to the ejecting portion D[j] and a wiring Ld through which the bias potential VBS is supplied.

The switching circuit 18 includes M switches SWa[1] to SWa[M] corresponding to the M ejecting portions D[1] to D[M] on a one-to-one basis, M switches SWb[1] to SWb[M] corresponding to the M ejecting portions D[1] to D[M] on a one-to-one basis, and M switches SWs[1] to SWs[M] corresponding to the M ejecting portions D[1] to D[M] on a one-to-one basis. Further, the switching circuit 18 includes a coupling state designation circuit CSC. The coupling state designation circuit CSC designates a coupling state of each of the M switches SWa, the M switches SWb, and the M switches SWs. For example, the coupling state designation circuit CSC may generate coupling state designation signals Qa[j], Qb[j], and Qs[j], based on at least some of the print signal SI, a latch signal LAT, a change signal CH, and a period designation signal Tsig supplied from the control unit 4. The coupling state designation signal Qa[j] is a signal that designates ON or OFF of the switch SWa[j], the coupling state designation signal Qb[j] is a signal that designates ON or OFF of the switch SWb[j], and the coupling state designation signal Qs[j] is a signal that designates ON or OFF of the switch SWs[j].

The switch SWa[j] switches between conduction and non-conduction between the wiring La and the individual electrode Zu[j] of the piezoelectric element PZ[j] provided in the ejecting portion D[j] based on the coupling state designation signal Qa[j]. That is, the switch SWa[j] switches between conduction and non-conduction between the wiring La and the wiring Li[j] coupled to the individual electrode Zu[j] based on the coupling state designation signal Qa[j]. In the present embodiment, the switch SWa[j] is turned on when the coupling state designation signal Qa[j] is at a high level, and is turned off when the coupling state designation signal Qa[j] is at a low level. When the switch SWa[j] is turned on, the drive signal COMa supplied to the wiring La is supplied to the individual electrode Zu[j] of the ejecting portion D[j] via the wiring Li[j] as the individual drive signal Vin[j].

The switch SWb[j] switches between conduction and non-conduction between the wiring Lb and the individual electrode Zu[j] of the piezoelectric element PZ[j] provided in the ejecting portion D[j] based on the coupling state designation signal Qb[j]. That is, the switch SWb[j] switches between conduction and non-conduction between the wiring Lb and the wiring Li[j] coupled to the individual electrode Zu[j] based on the coupling state designation signal Qb[j]. In the present embodiment, the switch SWb[j] is turned on when the coupling state designation signal Qb[j] is at a high level, and is turned off when the coupling state designation signal Qb[j] is at a low level. When the switch SWb[j] is turned on, the drive signal COMb supplied to the wiring Lb is supplied to the individual electrode Zu[j] of the ejecting portion D[j] via the wiring Li[j] as the individual drive signal Vin[j].

The switch SWs[j] switches between conduction and non-conduction between the wiring Ls and the individual electrode Zu[j] of the piezoelectric element PZ[j] provided in the ejecting portion D[j] based on the coupling state designation signal Qs[j]. That is, the switch SWs[j] switches between conduction and non-conduction between the wiring Ls and the wiring Li[j] coupled to the individual electrode Zu[j] based on the coupling state designation signal Qs[j]. In the present embodiment, the switch SWs[j] is turned on when the coupling state designation signal Qs[j] is at a high level, and is turned off when the coupling state designation signal Qs[j] is at a low level.

For example, the coupling state designation signal Qs[j] becomes a high level when residual vibration of the pressure chamber CV of the ejecting portion D[j] is detected. In the following, the pressure chamber CV, which is a detection target of the residual vibration, may be simply referred to as a pressure chamber CV, which is a detection target. In addition, in the following, the ejecting portion D including the pressure chamber CV as a detection target may be simply referred to as the ejecting portion D as a detection target.

When the coupling state designation signal Qs[j] becomes a high level, the switch SWs[j] is turned on, and the detection signal Vout[j] indicating a potential of the individual electrode Zu[j] of the ejecting portion D[j] as a detection target is supplied to the detection circuit 19 via the wiring Li[j] and the wiring Ls. The detection circuit 19 generates the residual vibration signal Vd[j] based on the detection signal Vout[j].

As described above, the individual drive signal Vin[j] is a signal supplied to the piezoelectric element PZ[j] of the ejecting portion D[j] via the switch SWa[j] or SWb[j], among the drive signals COMa and COMb.

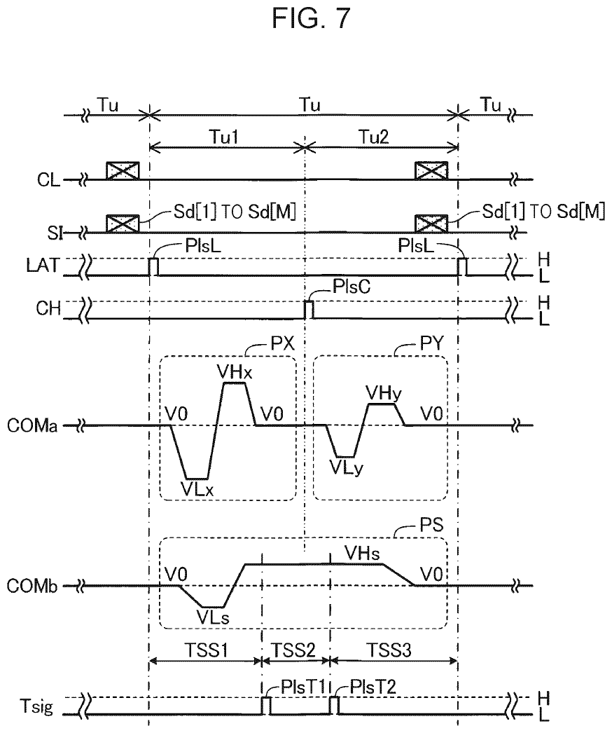

Next, an operation of the liquid ejecting apparatus 100 in a unit period Tu will be described with reference to FIG. 7.

FIG. 7 is a timing chart illustrating an example of the operation of the liquid ejecting apparatus 100 in the unit period Tu. In the present embodiment, when the liquid ejecting apparatus 100 executes a printing process, a printing process period including one or a plurality of unit periods Tu is set as an operation period of the liquid ejecting apparatus 100. The liquid ejecting apparatus 100 according to the present embodiment can drive each ejecting portion D for the printing process in each unit period Tu. Further, the liquid ejecting apparatus 100 according to the present embodiment can drive the ejecting portion D as a detection target and detect the detection signal Vout[j] from the ejecting portion D as a detection target in each unit period Tu.

The control unit 4 outputs the latch signal LAT having a pulse PlsL and the change signal CH having a pulse PlsC. Therefore, the control unit 4 defines the unit period Tu as a period from rising of the pulse PlsL to rising of the next pulse PlsL. The control unit 4 divides the unit period Tu into two control periods Tu1 and Tu2 with the pulse PlsC.

The print signal SI includes, for example, M individual designation signals Sd[1] to Sd[M] corresponding to the M ejecting portions D[1] to D[M] on a one-to-one basis. The individual designation signal Sd[j] designates a mode of the driving of the ejecting portion D[j] in each unit period Tu when the liquid ejecting apparatus 100 executes the printing process.

The control unit 4 supplies the print signal SI including the individual designation signals Sd[1] to Sd[M] to the coupling state designation circuit CSC in synchronization with a clock signal CL before each unit period Tu in which the printing process is executed. The coupling state designation circuit CSC generates the coupling state designation signals Qa[j], Qb[j], and Qs[j] based on the individual designation signal Sd[j] in the unit period Tu.

In the present embodiment, a case is assumed in which the ejecting portion D[j] can form any one of a large dot, a medium dot smaller than the large dot, and a small dot smaller than the medium dot in the unit period Tu. Hereinafter, the amount of ink corresponding to a large dot may be referred to as a large amount of ink, the amount of ink corresponding to a medium dot may be referred to as a medium amount of ink, and the amount of ink corresponding to a small dot may be referred to as a small amount of ink.

For example, the individual designation signal Sd[j] is a signal for designating any one driving mode among five driving modes such as ejection of a large amount of ink, ejection of a medium amount of ink, ejection of a small amount of ink, non-ejection of inks, and driving as the ejecting portion D as a detection target in each unit period Tu for the ejecting portion D[j]. For example, when the individual designation signal Sd[j] is a digital signal of 3 bits, one driving mode among the five driving modes can be designated by the individual designation signal Sd[j]. The individual designation signal Sd[j] may be a digital signal of 4 bits or more.

As illustrated in FIG. 7, the drive signal generation unit 2 outputs the drive signal COMa having a pulse PX and a pulse PY. A waveform of the drive signal COMa in the control period Tu1 corresponds to the pulse PX, and a waveform of the drive signal COMa in the control period Tu2 corresponds to the pulse PY.

In the present embodiment, the pulse PX and the pulse PY are defined such that a potential difference between the highest potential VHx and the lowest potential VLx of the pulse PX is more than a potential difference between the highest potential VHy and the lowest potential VLy of the pulse PY. Specifically, when the ejecting portion D[j] is driven by the drive signal COMa having the pulse PX, a waveform of the pulse PX is defined such that a medium amount of ink is ejected from the ejecting portion D[j]. When the ejecting portion D[j] is driven by the drive signal COMa having the pulse PY, a waveform of the pulse PY is defined such that a small amount of ink is ejected from the ejecting portion D[j]. The potentials at a start and an end of the pulse PX and the pulse PY are set to a reference potential VO.

When the individual designation signal Sd[j] designates the ejecting portion D[j] to form a large dot, the coupling state designation circuit CSC sets the coupling state designation signal Qa[j] to a high level in the control periods Tu1 and Tu2, and sets the coupling state designation signals Qb[j] and Qs[j] to a low level in the unit period Tu. In this case, the ejecting portion D[j] is driven by the pulse PX of the drive signal COMa in the control period Tu1 to eject a medium amount of ink, and is driven by the pulse PY of the drive signal COMa in the control period Tu2 to eject a small amount of ink. Therefore, the ejecting portion D[j] ejects a large amount of ink in total in the unit period Tu, and thus a large dot is formed at the medium PP.

Further, when the individual designation signal Sd[j] designates the ejecting portion D[j] to form a medium dot, the coupling state designation circuit CSC sets the coupling state designation signal Qa[j] to a high level in the control period Tu1 and to a low level in the control period Tu2, respectively, and sets the coupling state designation signals Qb[j] and Qs[j] to a low level in the unit period Tu. In this case, the ejecting portion D[j] ejects a medium amount of ink in the unit period Tu, and a medium dot is formed at the medium PP.

In addition, when the individual designation signal Sd[j] designates the ejecting portion D[j] to form a small dot, the coupling state designation circuit CSC sets the coupling state designation signal Qa[j] to a low level in the control period Tu1 and to a high level in the control period Tu2, respectively, and sets the coupling state designation signals Qb[j] and Qs[j] to a low level in the unit period Tu. In this case, the ejecting portion D[j] ejects a small amount of ink in the unit period Tu, and a small dot is formed at the medium PP.

Further, when the individual designation signal Sd[j] designates non-ejection of inks to the ejecting portion D[j], the coupling state designation circuit CSC sets the coupling state designation signals Qa[j], Qb[j], and Qs[j] to a low level in the unit period Tu. In this case, the ejecting portion D[j] does not eject the ink, and does not form a dot on the medium PP in the unit period Tu.

The drive signal generation unit 2 outputs the drive signal COMb having a pulse PS. A waveform of the drive signal COMb in the unit period Tu corresponds to the pulse PS. In the present embodiment, the pulse PS is defined such that a potential difference between the highest potential VHs and the lowest potential VLs of the pulse PS is less than a potential difference between the highest potential VHy and the lowest potential VLy of the pulse PY. Specifically, when the drive signal COMb having the pulse PS is supplied to the ejecting portion D[j], a waveform of the pulse PS is defined to drive the ejecting portion D[j] to such an extent that an ink is not ejected from the ejecting portion D[j]. The potentials at a start and an end of the pulse PS are set to the reference potential VO.

The control unit 4 outputs the period defining signal Tsig having a pulse PlsT1 and a pulse PlsT2. Therefore, the control unit 4 divides the unit period Tu into a control period TSS1 from a start of the pulse PlsL to a start of the pulse PlsT1, a control period TSS2 from a start of the pulse PlsT1 to a start of the pulse PlsT2, and a control period TSS3 from a start of the pulse PlsT2 to a start of the next pulse PlsL.

When the individual designation signal Sd[j] designates the ejecting portion D[j] as the ejecting portion D as a detection target, the coupling state designation circuit CSC respectively sets the coupling state designation signal Qa[j] to a low level in the unit period Tu and the coupling state designation signal Qb[j] to a high level in the control periods TSS1 and TSS3 and to a low level in the control period TSS2, and respectively sets the coupling state designation signal Qs[j] to a low level in the control periods TSS1 and TSS3 and to a high level in the control period TSS2.

In this case, the ejecting portion D as a detection target is driven by the pulse PS of the drive signal COMb in the control period TSS1. Specifically, the piezoelectric element PZ included in the ejecting portion D as a detection target is displaced by the pulse PS of the drive signal COMb in the control period TSS1. As a result, vibration is generated in the ejecting portion D as a detection target. The vibration generated in the control period TSS1 remains in the control period TSS2. In the control period TSS2, a potential of the individual electrode Zu of the piezoelectric element PZ included in the ejecting portion D as a detection target is changed according to the residual vibration generated in the ejecting portion D as a detection target. That is, in the control period TSS2, the potential of the individual electrode Zu of the piezoelectric element PZ included in the ejecting portion D as a detection target is a potential according to an electromotive force of the piezoelectric element PZ caused by the residual vibration generated in the ejecting portion D as a detection target. The potential of the individual electrode Zu is detected as the detection signal Vout in the control period TSS2.

In FIG. 7, a case is illustrated in which the detection signal Vout indicating the residual vibration of the ejecting portion D as a detection target is generated during the printing process period is illustrated, and the detection signal Vout indicating the residual vibration of the ejecting portion D as a detection target may be generated during a period different from the printing process period. That is, the process of detecting the residual vibration of the ejecting portion D as a detection target may be executed in a period different from the printing process period.

The operation of the liquid ejecting apparatus 100 is not limited to the example illustrated in FIG. 7. For example, in FIG. 7, a case where a size of the dot that can be formed at the medium PP is limited to three types of large, medium, and small is illustrated. Meanwhile, the size of the dot that can be formed at the medium PP is not limited to three types. Specifically, the size of the dot that can be formed at the medium PP may be one type or two types. The plurality of drive signals COM may include the drive signal COM other than the drive signals COMa and COMb. For example, the drive signal COM having a minute vibration waveform for applying minute vibration to the ink inside the ejecting portion D to prevent the ink from being thickened may be included in the plurality of drive signals COM.

Next, an outline of an operation of the circulation control portion 40 will be described with reference to FIG. 8.

FIG. 8 is an explanatory diagram describing the outline of the operation of the circulation control portion 40. FIG. 8 illustrates a graph describing a relationship between a flow rate of an ink and a flow path resistance, and an equivalent circuit which is an equivalent circuit diagram of a flow path provided in the liquid ejecting head 1. An arrow of a broken line of the equivalent circuit in FIG. 8 indicates the flow of the ink. In addition, in the graph in FIG. 8, a horizontal axis indicates the flow rate of the ink, and a vertical axis indicates the flow path resistance. A flow path resistance Rin is, for example, a flow path resistance of a flow path from the coupling port H1 to the M nozzles N. The flow path from the coupling port H1 to the nozzle N includes, for example, the common flow path RC1 and the individual flow path RKin. In addition, a flow path resistance Rout is, for example, a flow path resistance of a flow path from the nozzle N to the coupling port H2. The flow path from the nozzle N to the coupling port H2 includes, for example, the common flow path RC1 and the individual flow path RKout. As described in FIG. 5, the individual flow path RKin is a portion of the individual flow path RK between the common flow path RC1 and the nozzle N. Further, the individual flow path RKin is a portion of the individual flow path RK between the nozzle N and the common flow path RC2.

The circulation control portion 40 controls the pumps 63 and 64 to adjust the pressure Pn in the vicinity of the nozzle N to an appropriate pressure. Meanwhile, in the present embodiment, as described above, since the filter FL is provided only in the common flow path RC1 of the common flow paths RC1 and RC2, it is necessary to consider the flow path resistances Rin and Rout to adjust the pressure Pn to the appropriate pressure.

In general, a flow path resistance R is represented by Equation (1), by using a constant A and a constant B determined by a shape of the flow path, a viscosity μ of the ink, a mass m of the ink, and a flow rate F of the ink. In addition, the “*” in Equation (1) indicates multiplication, and the “A” in Equation (1) indicates exponentiation.

R=A*μ*F+B*m*F\hat{ }2 (1)

In the flow path resistance R, “A*μ*F” in Equation (1) is a resistance determined according to the viscosity μ of the ink, that is, a viscous resistance. In addition, in the flow path resistance R, “B*m*F\hat{ }2” in Equation (1) is a resistance depending on the shape of the flow path, that is, corresponds to an inertial resistance.

Here, since the common flow path RC1 is provided with the filter FL, the viscous resistance is dominant over the inertial resistance in the flow path resistance Rin of the flow path including the common flow path RC1. Therefore, in Equation (1), the inertial resistance can be ignored and the flow path resistance Rin can be approximated. That is, the flow path resistance Rin is represented by Equation (2) by using, for example, a constant Ain determined by the shape of the flow path from the coupling port H1 to the nozzle N, the viscosity μ of the ink, and the flow rate F of the ink. Rin=Ain*μ*F . . . (2)

On the other hand, since the filter FL is provided in the common flow path RC2, both the viscous resistance and the inertial resistance act on the flow path resistance Rout of the flow path including the common flow path RC2. Therefore, the flow path resistance Rout is represented by Equation (3) by using, for example, a constant Aout and a constant Bout determined by the shape of the flow path from the nozzle N to the coupling port H2, the viscosity μ of the ink, the mass m of the ink, and the flow rate F of the ink.

Rout=Aout*μ*F+Bout*m*F\hat{ }2 (3)

As is clear from Equation (2) and Equation (3), values of the flow path resistances Rin and Rout and a balance between the flow path resistances Rin and Rout is changed according to the flow rate F. The balance between the flow path resistances Rin and Rout is, for example, a ratio or a difference between the flow path resistances Rin and Rout. As illustrated in the graph in FIG. 8, for example, the balance between the flow path resistances Rin1 and Rout1 when the flow rate F is the flow rate F1 is different from the balance between the flow path resistances Rin2 and Rout2 when the flow rate F is the flow rate F2.

In this manner, in the present embodiment, in one flow path resistance R of the common flow paths RC1 and RC2, for example, the flow path resistance Rin, the viscous resistance is more than the inertial resistance, and in the other flow path resistance R of the common flow paths RC1 and RC2, for example, the flow path resistance Rout, the inertial resistance is more than the viscous resistance.

In addition, as illustrated in the equivalent circuit in FIG. 8, the pressure Pn in the vicinity of the nozzle Nis represented by using the flow path resistances Rin and Rout and the pressures Pin and Pout. For example, a flow speed of the ink is represented by Equation (4) by using the flow path resistances Rin and Rout and the pressures Pin, Pout, and Pn. Equation (5) representing the pressure Pn is derived from Equation (4).

Flow speed=(Pin−Pn)/Rin=(Pn−Pout)/Rout (4)

Pn=(Pin*Rout+Pout*Rin)/(Rin+Rout) (5)

Here, for example, when the same filters FL are provided in both a flow path from the coupling port H1 to the nozzle N and a flow path from the coupling port H2 to the nozzle N, or when the filters FL are not provided in both the flow paths and shapes of the flow paths are the same as each other, ideally, the flow path resistances Rin and Rout are equal to each other. In this case, when “Rin=Rout” is substituted into Equation (5), “Rin” and “Rout” disappear from Equation (5), and thus the pressure Pn is represented by “(Pin+Pout)/2”. Therefore, in the example described above in which the flow path resistances Rin and Rout are equal to each other, the pressure Pin and Pout that make the pressure Pn an appropriate pressure can be determined based on an equation of “Pn=(Pin+Pout)/2”, that is, the equation that does not include the flow path resistances Rin and Rout.

Meanwhile, in the present embodiment, since the filter FL is provided only in the common flow path RC1 of the common flow paths RC1 and RC2, a change in flow path resistance R according to the viscosity μ of the ink differs between the common flow path RC1 and the common flow path RC2. Specifically, when focusing on the flow rate F, the flow path resistance Rin is a first-order equation and the flow path resistance Rout is a second-order equation, as illustrated in Equation (2) and Equation (3). Therefore, “Rin” and “Rout” in Equation (5) do not disappear from Equation (5). Therefore, in the configuration of the present embodiment, when the pressures Pin and Pout are adjusted without considering the flow path resistances Rin and Rout, it is difficult to adjust the pressure Pn in the vicinity of the nozzle N to the appropriate pressure. Therefore, in the present embodiment, the circulation control portion 40 adjusts the pressure Pn to the appropriate pressure by adjusting the pressures Pin and Pout by considering the flow path resistances Rin and Rout.

For example, in Equation (1) representing the flow path resistance R, the constant A and the constant B are constants determined by the shape of the flow path, and thus are known values in a head manufacturer that manufactures the liquid ejecting head 1. In addition, the mass m of the ink is a coefficient that is a value which can be known in advance by a manufacturer or the like that uses the liquid ejecting head 1 since the mass m is determined by the ink used. In addition, the flow rate F of the ink can be adjusted by using a flowmeter or the like, and thus can be adjusted to a desired value. Therefore, when the flow rate F of the ink is adjusted to the desired value, the variable in Equation (1) representing the flow path resistance R is only the viscosity μ of the ink. That is, by specifying the viscosity μ of the ink, the flow path resistances Rin and Rout can be calculated from Equation (2) and Equation (3). In addition, by using the flow path resistances Rin and Rout calculated based on the viscosity μ of the ink, the pressures Pin and Pout for making the pressure Pn in the vicinity of the nozzle N the appropriate pressure can be calculated from Equation (5).

In the present embodiment, the circulation control portion 40 determines the pressures Pin and Pout for making the pressure Pn in the vicinity of the nozzle N the appropriate pressure, respectively, by using the flow path resistances Rin and Rout calculated based on the viscosity μ estimated by the viscosity estimation portion 3, for example. Since the viscosity μ is estimated based on residual vibration, determining of each of the pressures Pin and Pout by using the flow path resistances Rin and Rout calculated based on the viscosity μ is equivalent to determining of each of the pressures Pin and Pout based on the residual vibration.

Next, an operation of the liquid ejecting apparatus 100 will be described with reference to FIG. 9.

FIG. 9 is a flowchart illustrating an example of the operation of the liquid ejecting apparatus 100. In FIG. 9, an operation of the circulation control portion 40 that determines each of the pressures Pin and Pout will be mainly described.

First, in step S100, the control unit 4 functions as the circulation control portion 40, and causes the detection circuit 19 to detect residual vibration. Specifically, the circulation control portion 40 outputs the individual designation signal Sd for designating any one of the M ejecting portions D as the ejecting portion D as a detection target to the coupling state designation circuit CSC. Therefore, the detection circuit 19 acquires the detection signal Vout indicating the residual vibration of the ejecting portion D, which is a detection target, and outputs the residual vibration signal Vd generated based on the detection signal Vout to the viscosity estimation portion 3.

Next, in step S120, the control unit 4 functions as the circulation control portion 40, and acquires the viscosity information Vinf indicating the viscosity μ of an ink from the viscosity estimation portion 3. For example, the viscosity estimation portion 3 estimates the viscosity μ of the ink based on the residual vibration signal Vd supplied from the detection circuit 19 by the process in step S100. The viscosity estimation portion 3 outputs the viscosity information Vinf indicating the viscosity μ of the ink estimated based on the residual vibration signal Vd to the control unit 4. Therefore, the circulation control portion 40 acquires the viscosity information Vinf indicating the viscosity μ of the ink estimated based on the residual vibration signal Vd.

Next, in step S140, the control unit 4 functions as the circulation control portion 40, and determines the pressure Pin for supplying the ink to the common flow path RC1 and the pressure Pout for discharging the ink from the common flow path RC2, respectively, based on the viscosity information Vinf. Specifically, the circulation control portion 40 determines the pressure value of each of the pressures Pin and Pout for making the pressure Pn in the vicinity of the nozzle N the appropriate pressure, based on the viscosity μ indicated by the viscosity information Vinf, Equations (2), (3), and (5) described above. The determination of the pressure Pin and the pressure Pout is not limited to the determination of the pressure values themselves. For example, determining how much the pressure Pin and the pressure Pout are increased or decreased from the current pressure is also included in the determination of the pressure Pin and the pressure Pout.

Further, when there are a plurality of candidates for a combination of the viscosity μ indicated by the viscosity information Vinf and the pressures Pin and Pout calculated based on the Equations (2), (3), and (5) described above, the circulation control portion 40 selects one candidate from the plurality of candidates. For example, a case is assumed in which the viscosity μ indicated by the viscosity information Vinf, Equation (2), Equation (3), and Equation (5) described above are used to derive “Pn=C*Pin+D*Pout” and “C=1, D=2”. Further, a case where the pressure Pn is set to 10 will be considered. In this case, the plurality of candidates such as “(Pin, Pout)=(30, −10)”, “(Pin, Pout)=(50, −20)”, and “(Pin, Pout)=(2, 4)” are calculated.

Normally, the pressure Pin is a positive pressure, and the pressure Pout is a negative pressure. Therefore, for example, the circulation control portion 40 does not adopt the candidate of “(Pin, Pout)=(2, 4)”. In addition, since both “(Pin, Pout)=(30, −10)” and “(Pin, Pout)=(50, −20)” are combinations of positive pressure and negative pressure, the circulation control portion 40 determines the combination of the pressures Pin and Pout based on, for example, whether or not to increase a flow rate of the ink.

For example, in a case of “(Pin, Pout)=(30, −10)”, a difference between the pressures Pin and Pout is 40, and in a case of “(Pin, Pout)=(50, −20)”, the difference between the pressures Pin and Pout is 70. When the difference between the pressures Pin and Pout is large, the flow rate of the ink is increased, as compared with a case where the difference between the pressures Pin and Pout is small. When it is desired to prevent the increase in the circulation flow rate of the ink, the circulation control portion 40 selects the combination of “(Pin, Pout)=(30, −10)”. In addition, the combination of “(Pin, Pout)=(30, −10)” can reduce a load on the pumps 63 and 64 as compared with the combination of “(Pin, Pout)=(50, −20)” since both an absolute value of the pressure Pin and an absolute value of the pressure Pout are lower. In addition, when the emphasis is placed on the elimination of the increase in the viscosity of the ink by the circulation, the circulation control portion 40 increases the circulation flow rate of the ink by selecting the combination of “(Pin, Pout)=(50, −20)”.

Further, the circulation control portion 40 may present the plurality of candidates for the combination of the pressures Pin and Pout to a user, and acquire selection information indicating a candidate selected by the user among the candidates presented to the user. The circulation control portion 40 may select a candidate indicated by the selection information from the plurality of candidates as a combination of the pressure Pin and the pressure Pout. The circulation control portion 40 may present some candidates of the plurality of candidates for the combination of the pressures Pin and Pout to the user. For example, when a candidate in which the pressure Pout is a positive pressure or the pressure Pin is a negative pressure is included in the plurality of candidates, the circulation control portion 40 may present, to the user, a candidate other than the candidate in which the pressure Pout is a positive pressure or the pressure Pin is a negative pressure, among the plurality of candidates. In the above example, the circulation control portion 40 may present the user with “(Pin, Pout)=(50, −20)” and “(Pin, Pout)=(30, −10)”, which are candidates other than “(Pin, Pout)=(2, 4)” among three candidates. Further, the circulation control portion 40 presents all the three candidates to the user, and may present the recommendation of “(Pin, Pout)=(50, −20)” among the three candidates. The presentation referred to here can be appropriately adopted as long as the candidate can be transmitted to the user, and as an example, refers to displaying information indicating the candidate on a display of a computer owned by the user in a visually recognizable manner.

In this manner, in the present embodiment, the circulation control portion 40 determines each of the pressure Pin and the pressure Pout for making the pressure Pn the appropriate pressure, based on the viscosity μ of the ink estimated based on the residual vibration detected by the detection circuit 19. Therefore, in the present embodiment, the pressure Pn can be appropriately adjusted, as compared with a comparative example in which the pressure Pin and the pressure Pout are determined without using residual vibration. The comparative example is an aspect in which the pressure Pin and the pressure Pout are determined without using the residual vibration is, for example, a method of determining the pressure Pin and Pout, based on an equation of “Pn=(Pin+Pout)/2” described above, that is, the equation that does not include the flow path resistances Rin and Rout.

In the above description, in the present embodiment, the liquid ejecting apparatus 100 includes the piezoelectric element PZ, the plurality of individual flow paths RK each including the nozzle N and the pressure chamber CV, the common flow path RC1 which communicates in common with the plurality of individual flow paths RK and through which an ink is supplied to the plurality of individual flow paths RK, the common flow path RC2 which communicates in common with the plurality of individual flow paths RK and through which the ink is discharged from the plurality of individual flow paths RK, the pump 63 that applies the pressure Pin for supplying the ink to the common flow path RC1 to the common flow path RC1, the pump 64 that applies the pressure Pout for discharging the ink from the common flow path RC2 to the common flow path RC2, the detection circuit 19 that detects residual vibration in the pressure chamber CV after a voltage is applied to the piezoelectric element PZ, and the circulation control portion 40 that determines the pressure Pin and the pressure Pout based on the residual vibration detected by the detection circuit 19. For example, the control program PG of the liquid ejecting apparatus 100 causes the control unit 4 to function as the circulation control portion 40.

In this manner, in the present embodiment, the circulation control portion 40 determines each of the pressure Pin and the pressure Pout based on the residual vibration detected by the detection circuit 19. Therefore, in the present embodiment, the pressure Pin and the pressure Pout for making the pressure Pn in the vicinity of the nozzle N an appropriate pressure can be determined with higher accuracy, as compared with the comparative example in which the pressure Pin and the pressure Pout are determined without using the residual vibration. As a result, in the present embodiment, the pressure Pn in the vicinity of the nozzle N can be appropriately adjusted.

In the present embodiment, a change in flow path resistance R according to the viscosity μ of the ink differs between the common flow path RC1 and the common flow path RC2. Also in this case, in the present embodiment, each of the pressure Pin and the pressure Pout is determined based on the residual vibration, and thus the pressure Pn in the vicinity of the nozzle N can be appropriately adjusted. That is, in the present embodiment, the pressure Pn in the vicinity of the nozzle N can be appropriately adjusted, even for the liquid ejecting head 1 in which a change in flow path resistance R according to the viscosity μ of the ink differs between the common flow path RC1 and the common flow path RC2.

In the present embodiment, in one flow path resistance R of the common flow path RC1 and the common flow path RC2, the viscous resistance is more than the inertial resistance, and in the other flow path resistance R of the common flow path RC1 and the common flow path RC2, the inertial resistance is more than the viscous resistance. Also in this case, in the present embodiment, each of the pressure Pin and the pressure Pout is determined based on the residual vibration, and thus the pressure Pn in the vicinity of the nozzle N can be appropriately adjusted. That is, in the present embodiment, the pressure Pn in the vicinity of the nozzle N can be appropriately adjusted even for the liquid ejecting head 1 in which the viscous resistance is more than the inertial resistance in one flow path resistance R of the common flow path RC1 and the common flow path RC2 and the inertial resistance is more than the viscous resistance in the other flow path resistance R.

In the present embodiment, the filter FL is provided in only one of the first flow path between the pump 63 and the plurality of individual flow paths RK and the second flow path between the pump 64 and the plurality of individual flow paths RK. The first flow path includes the common flow path RC1, and the second flow path includes the common flow path RC2. Even when the filter FL is provided in only one of the first flow path and the second flow path, in the present embodiment, the pressure Pin and the pressure Pout are respectively determined based on the residual vibration. Therefore, the pressure Pn in the vicinity of the nozzle N can be appropriately adjusted. That is, in the present embodiment, the pressure Pn in the vicinity of the nozzle N can be appropriately adjusted even for the liquid ejecting head 1 in which the filter FL is provided in only one of the first flow path and the second flow path.

In the present embodiment, only the plurality of individual flow paths RK serve as the flow path that communicates between the common flow path RC1 and the common flow path RC2. In this case, since there is no flow path other than the plurality of individual flow paths RK that communicates between the common flow path RC1 and the common flow path RC2, the calculation of the flow path resistances Rin and Rout in accordance with the viscosity μ can be prevented from becoming complicated.

In the present embodiment, the circulation control portion 40 may calculate a candidate for a combination of the pressure Pin and the pressure Pout based on the residual vibration detected by the detection circuit 19, and present the candidate to the user. The circulation control portion 40 may acquire selection information indicating a candidate selected by the user from the candidates presented to the user, and may determine each of the pressure Pin and the pressure Pout based on the selection information. In this case, since the user can select a combination of the pressure Pin and the pressure Pout, the combination of the pressure Pin and the pressure Pout for setting the pressure Pn in the vicinity of the nozzle N to an appropriate pressure can be appropriately determined. The user may select one candidate from the candidates presented by the circulation control portion 40. Therefore, for example, a work of the user for adjusting the pressure Pn to the appropriate pressure can be simplified.

In the present embodiment, the circulation control portion 40 may recommend some of the candidates when the candidates are presented to the user. In this case, the candidate for a recommendation target is a candidate for a combination of the pressure Pin and the pressure Pout determined based on the residual vibration, and is also a realistic candidate for other reasons. In other words, the unrecommended candidate is a combination of the pressure Pin and the pressure Pout determined based on the residual vibration, and is not practical for other reasons. As a result, the selection of the combination of the unrealistic pressure Pin and pressure Pout by the user can be prevented. The candidate as the combinations of the unrealistic pressure Pin and the pressure Pout includes, for example, a candidate in which the pressure Pout is a positive pressure or the pressure Pin is a negative pressure, a candidate in which the pressure Pin exceeds a capacity of the pump 63 or the pressure Pout exceeds a capacity of the pump 64, and the like. The recommendation referred to here is a presentation method that is preferentially selected for some of the candidates, as compared with the other candidates. For example, the candidate for a recommendation target may be highlight-displayed by changing a display color, increasing a display size, or the like such that the user can easily see the candidate. For example, when a screen for displaying a plurality of candidates selectable by moving a cursor or the like is presented on a display of the user, a default (initial) position of the cursor or the like may be set to the candidate for the recommended candidate.

### 2. Modification Example

Each embodiment above can be variously modified. A specific aspect of the modification will be described below. Two or more aspects selected in any manner from the following examples can be appropriately combined with each other within a range not inconsistent with each other. In addition, in the modification examples described below, elements having the same effects and functions as those of the embodiment will be given the reference numerals used in the description above, and each detailed description thereof will be appropriately omitted.

### First Modification Example

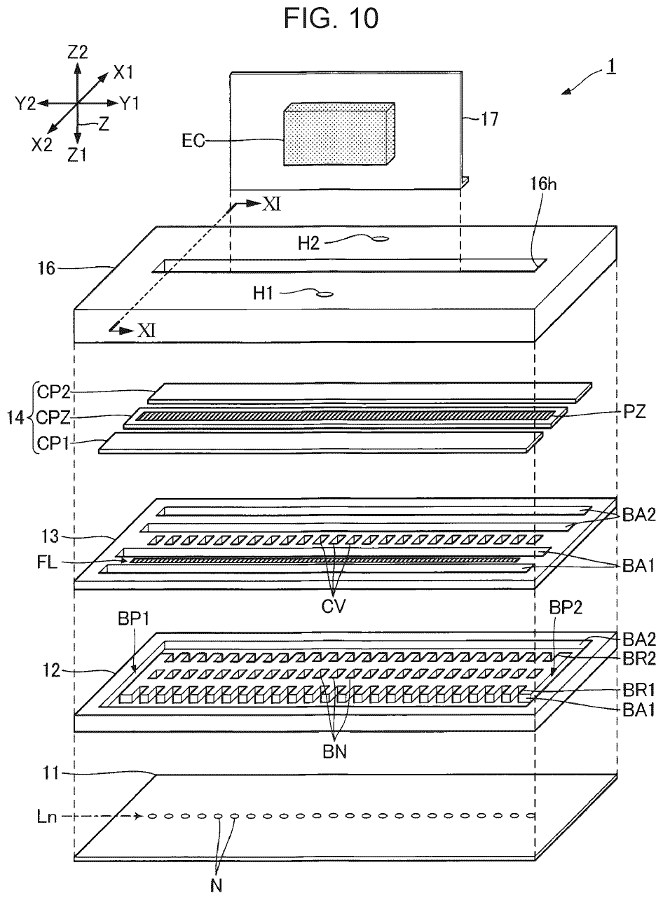

In the embodiment and the modification example described above, a case is described in which only the plurality of individual flow paths RK serve as the flow path that communicates between the common flow path RC1 and the common flow path RC2, and the present disclosure is not limited to such an aspect. For example, as illustrated in FIG. 10, the liquid ejecting apparatus 100 may further include bypass flow paths BP1 and BP2 that are flow paths separate from the plurality of individual flow paths RK and communicates between the common flow path RC1 and the common flow path RC2 with each other.

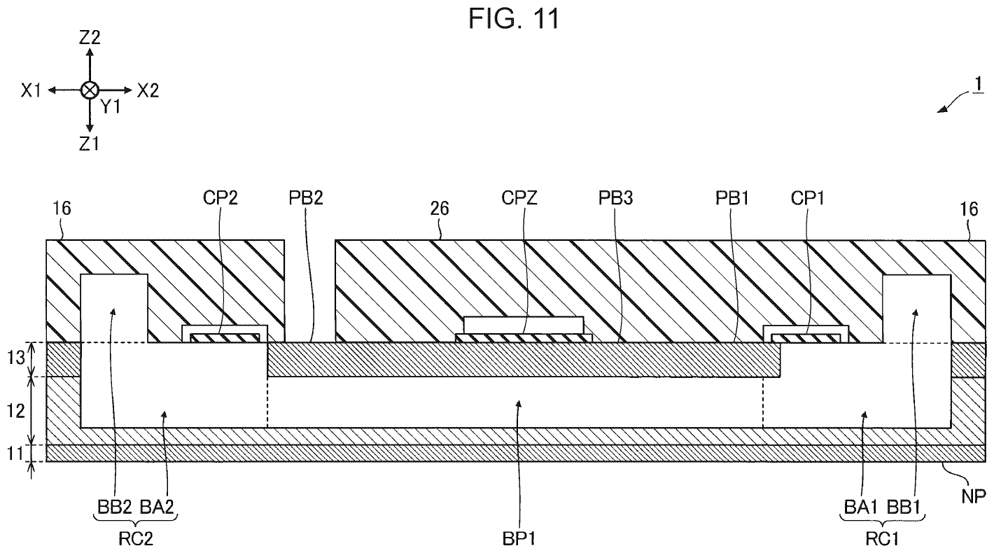

FIG. 10 is an exploded perspective view illustrating an example of a configuration of the liquid ejecting head 1 according to a first modification example. FIG. 11 is a cross-sectional diagram illustrating an example of the configuration of the liquid ejecting head 1 illustrated in FIG. 10. The cross-sectional diagram illustrated in FIG. 11 is a cross-sectional diagram taken along a line XI-XI illustrated in FIG. 10. A cross section taken along the line XI-XI is parallel to the XZ plane and passes through the bypass flow path BP1 to be described below. The same elements as those described in FIGS. 1 to 9 are denoted by the same reference signs, and detailed descriptions thereof will be omitted. The liquid ejecting head 1 according to the present aspect has the same manner as the liquid ejecting head 1 according to the embodiment described above, except that the bypass flow paths BP1 and BP2 are provided. In FIGS. 10 and 11, the bypass flow paths BP1 and BP2 will be mainly described.

As illustrated in FIGS. 10 and 11, the communication plate 12 is formed with one bypass flow path BP1 that couples the common flow path BA1 and the common flow path BA2 to each other and one bypass flow path BP2 that couples the common flow path BA1 and the common flow path BA2 to each other at a position in the Y1 direction with respect to the bypass flow path BP1. Each of the bypass flow path BP1 and the bypass flow path BP2 extends in the X-axis direction. In the following, the bypass flow path BP1 and the bypass flow path BP2 may be collectively referred to as a bypass flow path BP. One or both of the bypass flow path BP1 and the bypass flow path BP2 are examples of a “bypass flow path”.

In the present aspect, as illustrated in FIG. 11, a wall surface of the bypass flow path BP in the Z2 direction and a wall surface in the Z1 direction are formed in a flat shape. Meanwhile, the wall surface of the bypass flow path BP may include a surface that is inclined with respect to the YZ plane, in the same manner as the wall surface of the individual flow path RK. Alternatively, the wall surface of the bypass flow path BP may include a surface that is substantially parallel to the XZ plane. In the present aspect, a case is assumed as an example in which a wall surface defining an end portion of the bypass flow path BP in the Z1 direction is configured with the communication plate 12, and the end portion of the bypass flow path BP in the Z1 direction may be configured with the nozzle substrate 11. Further, in the present aspect, the nozzle N is not provided in the bypass flow path BP.

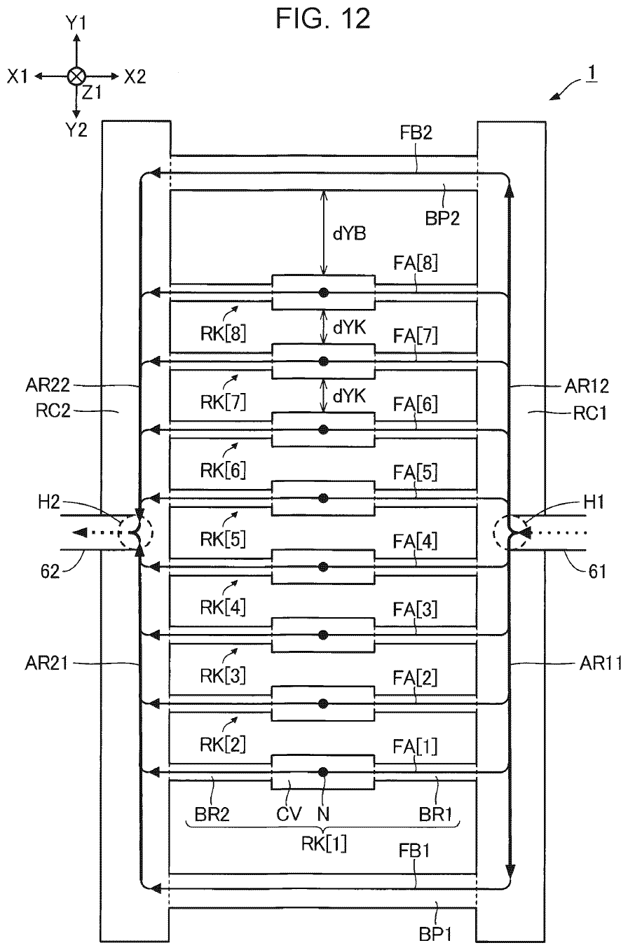

Next, a flow of an ink in the first modification example will be described with reference to FIG. 12.

FIG. 12 is an explanatory diagram describing the flow of the ink in the first modification example. FIG. 12 illustrates the flow of the ink in the common flow path RC and the individual flow path RK when the liquid ejecting head 1 is viewed in plan view in the Z1 direction. In FIG. 12 as well, in the same manner as FIG. 5, a case is assumed in which the value M is “8”, and a case is assumed in which each of the coupling port H1 and the coupling port H2 is located between the individual flow path RK[4] and the individual flow path RK[5] in the Y-axis direction.

Also in the present aspect, when the ink is circulated, the supply flow path 61 supplies the ink to the common flow path RC1, and the collection flow path 62 collects the ink from the common flow path RC2. For example, in the common flow path RC1, the ink flows from the coupling port H1 in the Y1 direction and the Y2 direction as illustrated by arrows AR11 and AR12. The ink flowing from the coupling port H1 in the Y1 direction is supplied to the individual flow paths RK[5] to RK[8] and the bypass flow path BP2, and the ink flowing from the coupling port H1 in the Y2 direction is supplied to the individual flow paths RK[1] to RK[4] and the bypass flow path BP1.

Further, in the individual flow path RK[j], the ink flows from the common flow path RC1 to the common flow path RC2 in the X1 direction as indicated by an arrow FA[j]. Therefore, for example, the pressure chamber CV provided in the individual flow path RK[j] is filled with the ink. In the bypass flow path BP, as illustrated by arrows FB1 and FB2, the ink flows from the common flow path RC1 to the common flow path RC2 in the X1 direction.

In addition, for example, in the common flow path RC2, as illustrated by arrows AR21 and AR22, an ink flows from the individual flow paths RK[1] to RK[4] and the bypass flow path BP1 in the Y1 direction, and an ink flows from the individual flow paths RK[5] to RK[8] and the bypass flow path BP2 in the Y2 direction. That is, the ink discharged from the individual flow paths RK[1] to RK[4] and the bypass flow path BP1 flows in the Y1 direction and is collected in the collection flow path 62 via the coupling port H2. Further, the ink discharged from the individual flow paths RK[5] to RK[8] and the bypass flow path BP2 flows in the Y2 direction and is collected in the collection flow path 62 via the coupling port H2.

In the following, as illustrated in FIG. 12, an interval between the bypass flow path BP and the individual flow path RK adjacent to the bypass flow path BP in the Y-axis direction is referred to as an interval dYB, and an interval between one individual flow path RK among the M individual flow paths RK and the other individual flow path RK adjacent to the one individual flow path RK in the Y-axis direction is referred to as an interval dYK. More specifically, an interval between the bypass flow path BP1 and the individual flow path RK[1] and an interval between the bypass flow path BP2 and the individual flow path RK[M] are referred to as the interval dYB, and an interval between the individual flow path RK[j1] and the individual flow path RK[j2] is referred to as the interval dYK. Here, the variable j1 and the variable j2 are natural numbers satisfying “1≤j1<j2≤M” and “1+j1=j2”.

In the present aspect, as illustrated in FIG. 12, the bypass flow path BP and the individual flow path RK are provided such that the interval dYB and the interval dYK satisfy “dYB>dYK”. Therefore, according to the present aspect, as compared with the aspect in which the interval dYB is less than the interval dYK, an influence of a noise such as vibration generated by the flow of the ink in the bypass flow path BP on the ink flowing through the individual flow path RK can be reduced. Therefore, according to the present aspect, a variation in the ejection characteristics of the ink from the M nozzles N included in the liquid ejecting head 1 can be reduced, as compared with the aspect in which the interval dYB is less than the interval dYK. Meanwhile, the present disclosure is not limited to the aspect in which the bypass flow path BP is provided such that the interval dYB is more than the interval dYK. That is, the bypass flow path BP may be provided such that the interval dYB is equal to or less than the interval dYK. In this case, the same effects as those of the embodiment described above can be obtained, except for the effect obtained by providing the bypass flow path BP such that the interval dYB is more than the interval dYK.

Further, in the present aspect, as illustrated in FIG. 12, the M individual flow paths RK are provided between the bypass flow path BP1 and the bypass flow path BP2. Therefore, according to the present aspect, a possibility that the ink stays at an end portion of the common flow path RC1 and an end portion of the common flow path RC2 can be reduced, as compared with the aspect in which one or both of the bypass flow path BP1 and the bypass flow path BP2 are provided between two individual flow paths RK among the M individual flow paths RK. Therefore, according to the present aspect, a possibility that the thickening of the ink, the retention of air bubbles in the ink, and the like occur at the end portion of the common flow path RC1 and the end portion of the common flow path RC2 can be reduced.

Here, a combined flow path resistance obtained by combining the flow path resistance R of the bypass flow path BP, that is, the flow path resistance R of the bypass flow path BP1 and the flow path resistance R of the bypass flow path BP2 is preferably ⅓ or more of a combined flow path resistance obtained by combining the flow path resistances R of the plurality of individual flow paths RK. In the present modification example, a case is assumed in which the flow path resistance R of the bypass flow path BP is equal to or more than ⅓ of the combined flow path resistance obtained by combining the flow path resistances R of the plurality of individual flow paths RK. In this case, the amount of ink passing through the bypass flow path BP is less than the amount of ink passing through the plurality of individual flow paths RK. Therefore, in the present modification example, the flow path resistances Rin and Rout corresponding to the viscosity μ of the ink can be accurately calculated even when the amount of ink passing through the bypass flow path BP is ignored. In other words, when the amount of ink passing through the bypass flow path BP is large, the amount of ink passing through the bypass flow path BP cannot be ignored when the flow path resistances Rin and Rout according to the viscosity μ of the ink are calculated, and thus the calculation of the flow path resistances Rin and Rout becomes complicated. That is, in the present modification example, the calculation of the flow path resistances Rin and Rout can be prevented from becoming complicated and the possibility that the thickening of the ink, the retention of air bubbles in the ink, and the like occur can be reduced. As a result, in the present modification example, the pressure Pn in the vicinity of the nozzle N can be appropriately adjusted while reducing the possibility that the thickening of the ink, the retention of air bubbles in the ink, and the like occur.

In the examples illustrated in FIGS. 10 to 12, the case is described in which the bypass flow path BP is formed in the communication plate 12, and the present disclosure is not limited to such an aspect. For example, the bypass flow path BP may be formed in the communication plate 12 and the pressure chamber substrate 13. Alternatively, the bypass flow path BP may be formed at a location different from the communication plate 12 and the pressure chamber substrate 13, for example, at a location positioned in the Z2 direction with respect to the pressure chamber substrate 13. In addition, in the example described above or when the known bypass flow path BP is adopted, it is preferable that the bypass flow path BP is formed such that the amount of ink passing through the bypass flow path BP does not exceed an amount that cannot be ignored when the flow path resistance R corresponding to the viscosity μ of the ink is calculated.

As described above, in the present modification example, the liquid ejecting apparatus 100 further includes the bypass flow path BP that is a flow path separate from the plurality of individual flow paths RK and communicates between the common flow path RC1 and the common flow path RC2. The flow path resistance R of the bypass flow path is equal to or more than ⅓ of the combined flow path resistance obtained by combining the flow path resistances R of the plurality of individual flow paths RK. In the present modification example as well, the same effect as the effect of the embodiment described above can be obtained. Further, in the present modification example, since the bypass flow path BP is provided, the possibility that the thickening of the ink, the retention of air bubbles in the ink, and the like occur can be reduced.

### Second Modification Example

In the embodiment and the modification example described above, the flow path including the common flow path RC1 and the individual flow path RKin and the flow path including the common flow path RC2 and the individual flow path RKout may be provided substantially symmetrically with the reference plane SF illustrated in FIG. 4 interposed therebetween. That is, a cross-sectional area of the common flow path RC1 with respect to a flow direction of the ink and a cross-sectional area of the common flow path RC2 with respect to the flow direction of the ink may be the same area as each other at positions which are symmetrical to the reference plane SF. The reference plane SF is, for example, a plane parallel to the YZ plane and is a plane passing through the nozzle N. That is, the reference plane SF is a plane passing through the nozzle N, among planes having a flow direction of the ink in the plurality of individual flow paths RK as a normal direction.

In this manner, in the present modification example, the cross-sectional area of the common flow path RC1 with respect to the flow direction of the ink and the cross-sectional area of the common flow path RC2 with respect to the flow direction of the ink are the same as each other at positions which are symmetrical to a plane passing through the nozzle N, among planes having the flow direction of the ink in the plurality of individual flow paths RK as the normal direction. Also in the present modification example, for example, a change in flow path resistance R according to the viscosity μ of the ink differs between the common flow path RC1 and the common flow path RC2 depending on the presence or absence of the filter FL. Therefore, also in the present modification example, the pressure Pn in the vicinity of the nozzle N can be appropriately adjusted, as compared with the comparative example to determine the pressure Pin and the pressure Pout without using the residual vibration.

### Third Modification Example

In the embodiment and the modification example described above, a case is described as an example in which the filter FL is provided only in the common flow path RC1 of the common flow paths RC1 and RC2, and the present disclosure is not limited to such an aspect. For example, the filter FL may be provided only in the common flow path RC2 of the common flow paths RC1 and RC2. In this case, in one flow path resistance R of the common flow paths RC1 and RC2, for example, in the flow path resistance Rout, the viscous resistance is more than the inertial resistance, and in the other flow path resistance R of the common flow paths RC1 and RC2, for example, in the flow path resistance Rin, the inertial resistance is more than the viscous resistance.

In addition, the filter FL may be provided in both the common flow paths RC1 and RC2, or the filter FL may not be provided in both the common flow paths RC1 and RC2. The reason that the change in flow path resistance R according to the viscosity μ of the ink differs between the common flow path RC1 and the common flow path RC2 is not limited to the presence or absence of the filter FL. For example, the change in flow path resistance R according to the viscosity μ of the ink may differ between the common flow path RC1 and the common flow path RC2 due to a manufacturing error or the like. Therefore, even with the configuration in which the filters FL are provided in both the common flow paths RC1 and RC2, the pressure Pn in the vicinity of the nozzle N can be appropriately adjusted, as compared with the comparative example in which the pressure Pin and the pressure Pout are determined without using the residual vibration. In the same manner, even with the configuration in which the filters FL are not provided in both the common flow paths RC1 and RC2, the pressure Pn in the vicinity of the nozzle N can be appropriately adjusted, as compared with the comparative example in which the pressure Pin and the pressure Pout are determined without using the residual vibration.

In addition, the filter FL may be provided in one or both of the supply flow path 61 and the collection flow path 62. When the filter FL is provided in one or both of the supply flow path 61 and the collection flow path 62, the filter FL may be provided in at least one of the common flow paths RC1 and RC2, or the filter FL may not be provided in both of the common flow paths RC1 and RC2.

As described above, also in the present modification example, the same effect as the effect of the embodiment and modification example described above can be obtained.

### Fourth Modification Example

In the embodiment and the modification example described above, a case is described as an example in which the vibration absorption plate CP1 and the vibration absorption plate CP2 are provided to be separated from each other, and the present disclosure is not limited to such an aspect. For example, the vibration absorption plate CP1 and the vibration absorption plate CP2 may be integrally formed. As described above, also in the present modification example, the same effect as the effect of the embodiment and modification example described above can be obtained.

### Fifth Modification Example

In the embodiment and the modification example described above, a compliance sheet that absorbs the pressure fluctuation of the ink in the common flow path BA may be provided. For example, the nozzle substrate 11 may be formed to have a length in the X-axis direction, which is less than the nozzle substrate 11 illustrated in FIG. 3, in the same manner as the diaphragm CPZ, and may be disposed between the two compliance sheets. Specifically, one of the two compliance sheets may be provided to close the common flow path BA1, at a position which is a position in the Z1 direction with respect to the communication plate 12 and in the X2 direction with respect to the nozzle substrate 11. The other of the two compliance sheets may be provided to close the common flow path BA2, at a position which is a position in the Z1 direction with respect to the communication plate 12 and in the X1 direction with respect to the nozzle substrate 11. As described above, also in the present modification example, the same effect as the effect of the embodiment and modification example described above can be obtained.

### Sixth Modification Example

In the embodiment and the modification example described above, the liquid ejecting apparatus 100 having a serial method in which the carriage 91 at which the liquid ejecting head 1 is mounted is reciprocated in the X-axis direction is described, and the present disclosure is not limited to such an aspect. For example, the liquid ejecting apparatus 100 may have a line method liquid ejecting apparatus in which the plurality of nozzles N are distributed over an entire width of the medium PP. As described above, also in the present modification example, the same effect as the effect of the embodiment and modification example described above can be obtained.

### Seventh Modification Example

In the embodiment and the modification example described above, a case is described as an example in which one piezoelectric element PZ, one pressure chamber CV, and one nozzle N are provided for one ejecting portion D, and the present disclosure is not limited to such an aspect. For example, one ejecting portion D may have two piezoelectric elements PZ, two pressure chambers CV, and one nozzle N. As described above, also in the present modification example, the same effect as the effect of the embodiment and modification example described above can be obtained.

### Eighth Modification Example

The liquid ejecting apparatus 100 described in the embodiment and the modification example described above can be adopted in various devices such as a facsimile machine and a copying machine, in addition to a device dedicated to printing. Moreover, the application of the liquid ejecting apparatus of the present disclosure is not limited to printing. For example, a liquid ejecting apparatus that ejects a solution of a coloring material is used as a manufacturing device that forms a color filter of a liquid crystal display device. In addition, a liquid ejecting apparatus that ejects a solution of a conductive material is used as a manufacturing apparatus that forms a wire or an electrode of a wiring substrate. As described above, also in the present modification example, the same effect as the effect of the embodiment and modification example described above can be obtained.

### 3. Appendixes

From the embodiments described above, for example, the following configuration can be ascertained.

According to Aspect 1 that is a preferred aspect, there is provided a liquid ejecting apparatus including: a piezoelectric element; a plurality of individual flow paths each including a nozzle and a pressure chamber; a common supply flow path which communicates in common with the plurality of individual flow paths and through which a liquid is supplied to the plurality of individual flow paths; a common discharge flow path which communicates in common with the plurality of individual flow paths and through which the liquid is discharged from the plurality of individual flow paths; a first pressure applying portion that applies a first pressure for supplying the liquid to the common supply flow path, to the common supply flow path; a second pressure applying portion that applies a second pressure for discharging the liquid from the common discharge flow path, to the common discharge flow path; a detection portion that detects residual vibration in the pressure chamber after a voltage is applied to the piezoelectric element; and a pressure determination portion that determines each of the first pressure and the second pressure based on the residual vibration detected by the detection portion.

With Aspect 1, the first pressure and the second pressure for making a pressure in the vicinity of the nozzle an appropriate pressure can be accurately determined. As a result, with Aspect 1, the pressure in the vicinity of the nozzle can be appropriately adjusted.

In the liquid ejecting apparatus according to Aspect 2 that is a specific example of Aspect 1, a change in flow path resistance according to a viscosity of the liquid differs between the common supply flow path and the common discharge flow path.

With Aspect 2, even for the liquid ejecting apparatus in which the change in flow path resistance according to the viscosity of the liquid differs between the common supply flow path and the common discharge flow path, the first pressure and the second pressure for making the pressure in the vicinity of the nozzle the appropriate pressure can be accurately determined.

In the liquid ejecting apparatus according to Aspect 3 that is a specific example of Aspect 1 or 2, in one flow path resistance of the common supply flow path and the common discharge flow path, a viscous resistance is more than an inertial resistance, and in another flow path resistance of the common supply flow path and the common discharge flow path, the inertial resistance is more than the viscous resistance.

With Aspect 3, even for the liquid ejecting apparatus in which the flow path resistance of one of the common supply flow path and the common discharge flow path has a viscous resistance more than an inertial resistance, and the flow path resistance of the other of the common supply flow path and the common discharge flow path has an inertial resistance more than a viscous resistance, the first pressure and the second pressure for making the pressure in the vicinity of the nozzle the appropriate pressure can be accurately determined.

In the liquid ejecting apparatus according to Aspect 4 that is a specific example of any one of Aspect 1 to Aspect 3, a filter is provided at only one of a first flow path between the first pressure applying portion and the plurality of individual flow paths and a second flow path between the second pressure applying portion and the plurality of individual flow paths, the first flow path includes the common supply flow path, and the second flow path includes the common discharge flow path.

With Aspect 4, even for the liquid ejecting apparatus in which the filter is provided in only one of the first flow path and the second flow path, the first pressure and the second pressure for making the pressure in the vicinity of the nozzle the appropriate pressure can be accurately determined.

In the liquid ejecting apparatus according to Aspect 5 that is a specific example of any one of Aspect 1 to Aspect 4, a cross-sectional area of the common supply flow path in a flow direction of the liquid and a cross-sectional area of the common discharge flow path in the flow direction of the liquid are the same as each other at positions which are symmetrical to a plane passing through the nozzle, among planes having the flow direction of the liquid in the plurality of individual flow paths as a normal direction.

With Aspect 5 as well, the first pressure and the second pressure for making the pressure in the vicinity of the nozzle the appropriate pressure can be accurately determined.

In the liquid ejecting apparatus according to Aspect 6 that is a specific example of any one of Aspect 1 to Aspect 5, only the plurality of individual flow paths serve as a flow path that communicates between the common supply flow path and the common discharge flow path.

With Aspect 6, the process of determining each of the first pressure and the second pressure based on the residual vibration can be prevented from becoming complicated.

The liquid ejecting apparatus according to Aspect 7 that is a specific example of any one of Aspect 1 to Aspect 5, further includes: a bypass flow path that is a flow path separate from the plurality of individual flow paths and that communicates between the common supply flow path and the common discharge flow path, in which a flow path resistance of the bypass flow path is equal to or more than ⅓ of a combined flow path resistance obtained by combining flow path resistances of the plurality of individual flow paths.

With Aspect 7, the possibility that the thickening of the ink, the retention of air bubbles in the ink, and the like occur can be reduced, and the first pressure and the second pressure for making the pressure in the vicinity of the nozzle the appropriate pressure can be accurately determined.

In the liquid ejecting apparatus according to Aspect 8 that is a specific example of any one of Aspect 1 to Aspect 7, the pressure determination portion calculates a candidate for a combination of the first pressure and the second pressure based on the residual vibration detected by the detection portion, presents the candidate to a user, acquires selection information indicating a candidate selected by the user, among candidates presented to the user, and determines each of the first pressure and the second pressure based on the selection information. With Aspect 8, the combination of the first pressure and the second pressure for making the pressure in the vicinity of the nozzle the appropriate pressure can be appropriately determined.

In the liquid ejecting apparatus according to Aspect 9 that is a specific example of Aspect 8, the pressure determination portion recommends some of the candidates when the candidates are presented to the user.

With Aspect 9, the presentation of the candidate of the combination of the first pressure and the second pressure that is not realistic to the user can be prevented. As a result, the selection of the combination of the first pressure and the second pressure which is not realistic by the user can be prevented.

According to Aspect 10 that is a preferred aspect, there is provided a control method for a liquid ejecting apparatus including a piezoelectric element, a plurality of individual flow paths each including a nozzle and a pressure chamber, a common supply flow path which communicates in common with the plurality of individual flow paths and through which a liquid is supplied to the plurality of individual flow paths, a common discharge flow path which communicates in common with the plurality of individual flow paths and through which the liquid is discharged from the plurality of individual flow paths, a first pressure applying portion that applies a first pressure for supplying the liquid to the common supply flow path, to the common supply flow path, a second pressure applying portion that applies a second pressure for discharging the liquid from the common discharge flow path, to the common discharge flow path, and a detection portion that detects residual vibration in the pressure chamber after a voltage is applied to the piezoelectric element, the method including: determining each of the first pressure and the second pressure based on the residual vibration detected by the detection portion.

With Aspect 10 as well, the first pressure and the second pressure for making the pressure in the vicinity of the nozzle the appropriate pressure can be accurately determined.

According to Aspect 11 that is a preferred aspect, there is provided a non-transitory computer-readable storage medium storing a control program for a liquid ejecting apparatus including a piezoelectric element, a plurality of individual flow paths each including a nozzle and a pressure chamber, a common supply flow path which communicates in common with the plurality of individual flow paths and through which a liquid is supplied to the plurality of individual flow paths, a common discharge flow path which communicates in common with the plurality of individual flow paths and through which the liquid is discharged from the plurality of individual flow paths, a first pressure applying portion that applies a first pressure for supplying the liquid to the common supply flow path, to the common supply flow path, a second pressure applying portion that applies a second pressure for discharging the liquid from the common discharge flow path, to the common discharge flow path, and a detection portion that detects residual vibration in the pressure chamber after a voltage is applied to the piezoelectric element, the control program causing a computer to function as: a pressure determination portion that determines each of the first pressure and the second pressure based on the residual vibration detected by the detection portion.

With Aspect 11 as well, the first pressure and the second pressure for making the pressure in the vicinity of the nozzle the appropriate pressure can be accurately determined.

What is claimed is:

1. A liquid ejecting apparatus comprising:
a piezoelectric element;
a plurality of individual flow paths each including a nozzle and a pressure chamber;
a common supply flow path which communicates in common with the plurality of individual flow paths and through which a liquid is supplied to the plurality of individual flow paths;
a common discharge flow path which communicates in common with the plurality of individual flow paths and through which the liquid is discharged from the plurality of individual flow paths;
a first pressure applying portion that applies a first pressure for supplying the liquid to the common supply flow path, to the common supply flow path;
a second pressure applying portion that applies a second pressure for discharging the liquid from the common discharge flow path, to the common discharge flow path;
a detection portion that detects residual vibration in the pressure chamber after a voltage is applied to the piezoelectric element; and
a pressure determination portion that determines each of the first pressure and the second pressure based on the residual vibration detected by the detection portion.

2. The liquid ejecting apparatus according to claim 1, wherein
a change in flow path resistance according to a viscosity of the liquid differs between the common supply flow path and the common discharge flow path.

3. The liquid ejecting apparatus according to claim 2, wherein
in one flow path resistance of the common supply flow path and the common discharge flow path, a viscous resistance is more than an inertial resistance, and
in another flow path resistance of the common supply flow path and the common discharge flow path, the inertial resistance is more than the viscous resistance.

4. The liquid ejecting apparatus according to claim 1, wherein
a filter is provided at only one of a first flow path between the first pressure applying portion and the plurality of individual flow paths and a second flow path between the second pressure applying portion and the plurality of individual flow paths,
the first flow path includes the common supply flow path, and
the second flow path includes the common discharge flow path.

5. The liquid ejecting apparatus according to claim 4, wherein
a cross-sectional area of the common supply flow path in a flow direction of the liquid and a cross-sectional area of the common discharge flow path in the flow direction of the liquid are the same as each other at positions which are symmetrical to a plane passing through the nozzle, among planes having the flow direction of the liquid in the plurality of individual flow paths as a normal direction.

6. The liquid ejecting apparatus according to claim 1, wherein
only the plurality of individual flow paths serve as a flow path that communicates between the common supply flow path and the common discharge flow path.

7. The liquid ejecting apparatus according to claim 1, further comprising:
a bypass flow path that is a flow path separate from the plurality of individual flow paths and that communicates between the common supply flow path and the common discharge flow path, wherein
a flow path resistance of the bypass flow path is equal to or more than ⅓ of a combined flow path resistance obtained by combining flow path resistances of the plurality of individual flow paths.

8. The liquid ejecting apparatus according to claim 1, wherein
the pressure determination portion
calculates a candidate for a combination of the first pressure and the second pressure based on the residual vibration detected by the detection portion,
presents the candidate to a user,
acquires selection information indicating a candidate selected by the user, among candidates presented to the user, and
determines each of the first pressure and the second pressure based on the selection information.

9. The liquid ejecting apparatus according to claim 8, wherein
the pressure determination portion recommends some of the candidates when the candidates are presented to the user.

10. A control method for a liquid ejecting apparatus including
a piezoelectric element,
a plurality of individual flow paths each including a nozzle and a pressure chamber,
a common supply flow path which communicates in common with the plurality of individual flow paths and through which a liquid is supplied to the plurality of individual flow paths,
a common discharge flow path which communicates in common with the plurality of individual flow paths and through which the liquid is discharged from the plurality of individual flow paths,
a first pressure applying portion that applies a first pressure for supplying the liquid to the common supply flow path, to the common supply flow path,
a second pressure applying portion that applies a second pressure for discharging the liquid from the common discharge flow path, to the common discharge flow path, and
a detection portion that detects residual vibration in the pressure chamber after a voltage is applied to the piezoelectric element, the method comprising:
determining each of the first pressure and the second pressure based on the residual vibration detected by the detection portion.

11. A non-transitory computer-readable storage medium storing a control program for a liquid ejecting apparatus including
a piezoelectric element,
a plurality of individual flow paths each including a nozzle and a pressure chamber,
a common supply flow path which communicates in common with the plurality of individual flow paths and through which a liquid is supplied to the plurality of individual flow paths,
a common discharge flow path which communicates in common with the plurality of individual flow paths and through which the liquid is discharged from the plurality of individual flow paths,
a first pressure applying portion that applies a first pressure for supplying the liquid to the common supply flow path, to the common supply flow path,
a second pressure applying portion that applies a second pressure for discharging the liquid from the common discharge flow path, to the common discharge flow path, and
a detection portion that detects residual vibration in the pressure chamber after a voltage is applied to the piezoelectric element, the control program causing a computer to function as:
a pressure determination portion that determines each of the first pressure and the second pressure based on the residual vibration detected by the detection portion.
